(19) United States
(12) Patent Application Publication
(10) Pub. No.: US 2018/0205458 A1
(43) Pub. Date: Jul. 19, 2018

(54) MODULATION OF NATURAL LIGHTING FOR VISIBLE LIGHT COMMUNICATION (VLC)

(71) Applicant: ABL IP HOLDING LLC, Conyers, GA (US)

(72) Inventors: Nathaniel W. HIXON, Arlington, VA (US); David P. RAMER, Reston, VA (US); Jack C. RAINS, JR., Herndon, VA (US); Januk AGGARWAL, Tysons Corner, VA (US)

(21) Appl. No.: 15/669,407

(22) Filed: Aug. 4, 2017

Related U.S. Application Data
(63) Continuation-in-part of application No. 15/200,375, filed on Jul. 1, 2016.

(51) Int. Cl. H04B 10/116; H04B 10/67; H04B 10/50; H04B 10/516; G02F 1/01

(52) U.S. Cl. CPC H04B 10/116; H04B 10/676; G02F 1/0126; H04B 10/516; H04B 10/501

(57) ABSTRACT

A system for modulating passive optical lighting or natural light for visible light communication (VLC) in a non-enclosed space to obtain precise location information or broadband data transmission. The system includes an optical modulator having a framing structure that is at least substantially transmissive with respect to visible light and that has a modulating layer attached thereon.

### RELATED APPLICATIONS

This application is a Continuation-In-Part (CIP) of U.S. application Ser. No. 15/200,375, filed Jul. 1, 2016 entitled “MODULATING PASSIVE OPTICAL LIGHTING,” the disclosure of which is entirely incorporated herein by reference.

### TECHNICAL FIELD

The present subject matter relates to techniques and equipment to modulate passive optical lighting for visible light communication (VLC).

### BACKGROUND

Visible light communication (VLC) is gaining in popularity for transmission of information in indoor locations, for example, from an artificial light source to a mobile device. The VLC transmission may carry broadband user data, if the mobile device has an optical sensor or detector capable of receiving the high speed modulated light carrying the broadband data. In other examples, the light is modulated at a rate and in a manner detectable by a typical imaging device (e.g. a rolling shutter camera). This later type of VLC, for example, may support an estimation of position of the mobile device and/or provide some information about the location of the mobile device. These VLC communication technologies have involved modulation of artificially generated light, for example, by controlling the power applied to the artificial light source(s) within a luminaire to modulate the output of the artificial light source(s) and thus the light output from the luminaire.

Luminaires, including those configured for VLC transmissions, consume power to drive the sources of artificial light. Power consumption for such lighting can be a major expense, e.g. for enterprises operating large numbers of artificial lighting devices; and generating and supplying such power raises environmental concerns. Also, for some applications, VLC performance improves if more and/or all sources of light illuminating a particular space are modulated.

In view of the power and environmental concerns, many installations do not rely solely on artificial lighting during daytime hours of operations. Daylighting is a practice of placing or constructing elements of a building to distribute daylight from outside the building into interior space(s) of the building, which may reduce the need for artificial lighting during daytime hours. Traditional examples of daylighting devices involved appropriate sizing and placement of windows in walls or doors of the building or of skylights or the like in roofs/ceilings of the building. More sophisticated daylighting equipment utilizes optical collectors, channels, reflectors and optical distributors to supply and distribute light from outside the building to regions of the interior space. Although various daylighting systems may be adjustable, they typically are passive in nature. The light supplied to the interior space is redirected (and/or produced in response to) sunlight from the exterior of the building. Artificial lighting may be combined with daylighting equipment, either in the form of luminaires in the vicinity of a daylighting device or by incorporation of an artificial light source within the same structure that implements the daylighting device. The addition of artificial lighting to a daylighting system provides additional light to the interior space, e.g. in regions where the daylighting may not be adequate and/or for days or times when the collected sunlight may not be sufficient.

The artificial light source(s) incorporated in a daylighting device and/or included in luminaires in the vicinity of a daylighting device may be modulated for VLC. However, the passively collected/distributed light of the daylighting device has not been modulated for VLC.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a simplified functional block diagram of a system including a passive optical element, an optical modulator and an associated controller.

FIG. 2 is a simplified functional block diagram of a visual light communication system with modulation of passive lighting, which also shows several types of other elements that may use or communicate with/through the visual light communication system.

FIG. 3 is a simplified functional block diagram of a controller and an associated optical modulator for use in/with a daylighting device.

FIG. 4 is a simplified functional block diagram of a general lighting luminaire, together with an associated controller, which includes a driver/modulator circuit.

FIG. 5 is a side elevational view of two skylights, each associated with an optical modulator, as well as a portion of a roof supporting the skylights.

FIGS. 6A and 6B are side and exploded views of a tubular prismatic skylight and associated optical modulator.

FIG. 7 depicts a phosphor or quantum dot (QD) and electrowetting-based optical modulator.

FIG. 8 depicts an optical modulator for light tubes.

FIG. 9 depicts an alternate modulator for light tubes.

FIG. 10 illustrates a further alternate modulator for light tubes.

FIG. 11 illustrates a further alternate modulator for light tubes.

FIG. 12 shows a segmented modulator, e.g. using a spatial pattern.

FIG. 13 is a simplified block diagram illustrating a technique to obtain power, e.g. for the optical modulator(s), through energy harvesting in or around a daylighting device.

FIG. 14 is a simplified functional block diagram of a mobile device, by way of an example of a portable handheld device.

FIG. 15 is a simplified functional block diagram of a personal computer or other work station or terminal device.

FIG. 16 is a simplified functional block diagram of a computer that may be configured as a host or server, for example, to function as the server in the system of FIG. 2.

FIG. 17A illustrates a system of extending VLC to an outdoor area or partially enclosed area in which a modulating layer is positioned overhead, and a mobile device has a direct view of a modulated signal or pattern.

FIG. 17B illustrates a system of extending VLC to an outdoor area or partially enclosed area having passive and artificial lighting in which a modulating layer is positioned overhead, and a mobile device has a direct view of a reflected modulated signal or pattern.

FIG. 17C illustrates a system of extending VLC to an outdoor area or partially enclosed area in which a modulating layer on a reflective layer modulates data on natural light, and a mobile device has a direct view of a reflected modulated signal or pattern.

FIG. 17D illustrates a system of extending VLC to an outdoor area or partially enclosed area in which a plurality of optical modulators each having a modulating layer on a reflective layer modulate data on natural light, and a mobile device has a direct view of a reflected modulated signal or pattern

FIG. 18 is a flowchart for a location determination for a mobile device in a direct view system providing VLC using modulated passive lighting in an outdoor or partially enclosed space.

FIG. 19A illustrates a system of extending VLC to an outdoor area or partially enclosed area in which a modulating layer is positioned overhead, and a mobile device has an indirect view of a projected modulated signal or pattern.

FIG. 19B illustrates a system of extending VLC to an outdoor area or partially enclosed area having passive and artificial lighting in which a modulating layer is positioned overhead, and a mobile device has an indirect view of a projected modulated signal or pattern.

FIG. 19C illustrates a system of extending VLC to an outdoor area or partially enclosed area in which a modulating layer is arranged on a reflective surface, and mobile device has an indirect view of a projected modulated signal or pattern.

FIG. 20 is a flowchart for a location determination for a mobile device in an indirect view system providing VLC using modulated passive lighting in an outdoor or partially enclosed space.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to techniques and equipment to modulate passive optical lighting, e.g. as supplied to an interior space via a daylighting device such as a skylight, window or the like, or natural light that is detectable in a non-enclosed space, such as an outdoor area or a partially enclosed area that is also partially open to the outdoors.

Visual light communication involves transport of information or other data over light in a range of frequencies/wavelengths typically considered to be visible to the human eye. Many of the specific examples discussed below involve modulation of light in the visual range, e.g. for capture and processing by cameras, image sensors or other light sensors configured to detect visible light. The present concepts, however, encompass modulation of light in other frequency/wavelength ranges outside the visible light range, e.g. ultraviolet and infrared. Passive lighting devices, for example, often allow passage of infrared light and some ultraviolet light, e.g. in addition to visible daylight, some or all of which may be modulated for various communication applications. The present teachings extend to modulation of natural light in other settings, e.g. outdoors, where the modulator is not part of a lighting “device” per se.

The term “lighting device” as used herein is intended to encompass essentially any type of device that processes, generates or supplies light, for example, for general illumination of a space intended for use of or occupancy or observation, typically by a living organism that can take advantage of or be affected in some desired manner by the light emitted from the device. However, a lighting device may provide light for use by automated equipment, such as sensors/monitors, robots, etc. that may occupy or observe the illuminated space, instead of or in addition to light provided for an organism. However, it is also possible that one or more lighting devices in or on a particular premises have other lighting purposes, such as signage for an entrance or to indicate an exit. Of course, the lighting devices may be configured for still other purposes, e.g. to benefit human or non-human organisms or to repel or even impair certain organisms or individuals. In most examples, the lighting device(s) illuminate a space or area of a premises to a level useful for a human in or passing through the space, e.g. regular illumination of a room or corridor in a building or of an outdoor space such as a street, sidewalk, parking lot or performance venue. The actual source of light in or supplying the light for a lighting device may be any type of light emitting, collecting or directing arrangement. The term “lighting device” encompasses passive lighting devices that collect and supply natural light as well as artificial lighting devices that include a source for generating light.

The term “passive lighting” as used herein is intended to encompass essentially any type of lighting that a device supplies without consuming power to generate the light. A passive lighting device, for example, may take the form of a daylighting device that supplies daylight that the device obtains outside a structure to the interior of the structure, e.g. to provide desired illumination of the interior space within the structure with otherwise natural light. As another example, a passive lighting device may include a phosphor or other wavelength conversion material, to enhance the light in a desired manner without consuming electrical power. A passive lighting device, however, may be combined with other elements that consume electrical power for other purposes, such as communications, data processing and/or modulation of otherwise passive lighting. For example, a modulated passive lighting device is a lighting device having a passive optical element and an associated optical modulator to modulate light supplied in some manner via the passive optical element, albeit without any consumption of power to generate the light to be supplied for illumination purposes (although power may be consumed to modulate passively obtained light).

The term “natural lighting” as used here is intended to encompass any type of light that comes from a source that is self-generating and not human-made. The sun is often viewed as the primary source of natural lighting; however, the stars and moon are also natural forms of light. Modulation of natural light may be implemented on or in association with a passive lighting device, such as a window or skylight. Some natural light, however, may be modulated without association with a passive lighting device, for example in partially open or outdoor areas exposed to direct illumination by the sun.

The term “artificial lighting” as used herein is intended to encompass essentially any type of lighting that a device produces by processing of electrical power to generate the light. An artificial lighting device, for example, may take the form of a lamp, light fixture or other luminaire that incorporates a source, where the source by itself contains no intelligence or communication capability, such as one or more LEDs or the like, or a lamp (e.g. “regular light bulbs”) of any suitable type.

The term “coupled” as used herein refers to any logical, physical or electrical connection, link or the like by which signals, data, instructions or the like produced by one system element are imparted to another “coupled” element. Unless described otherwise, coupled elements or devices are not necessarily directly connected to one another and may be separated by intermediate components, elements or communication media that may modify, manipulate or carry the signals.

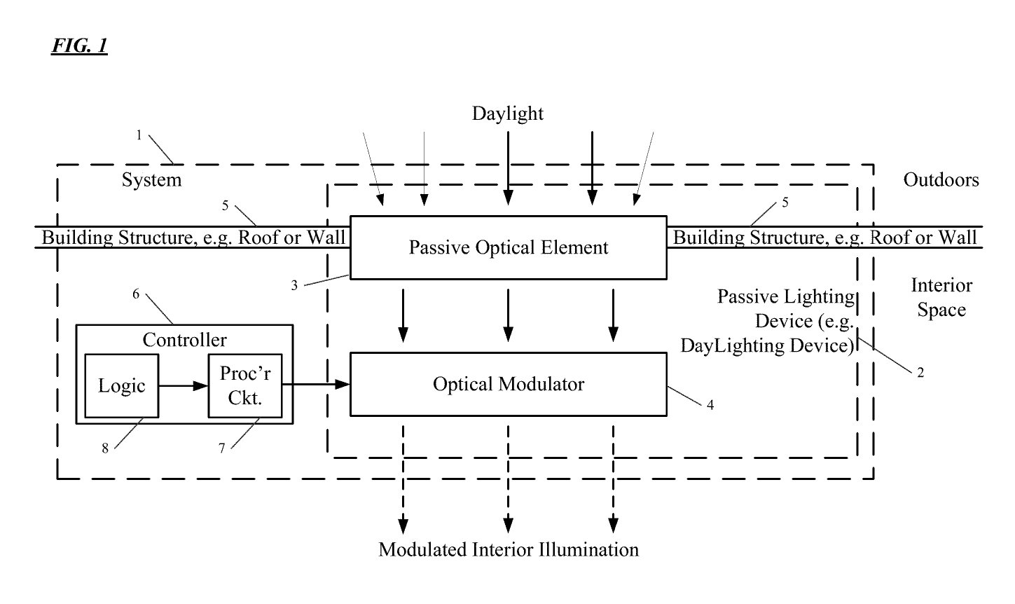

Reference now is made in detail to the examples illustrated in the accompanying drawings and discussed below. FIG. 1 illustrates an example of a system 1 that provides passive lighting as well as modulated light communication, in this case by modulating light otherwise passively supplied by a daylighting device to an interior space. The system 1 includes a passive lighting device 2, which in the example, includes a passive optical element 3 and an associated optical modulator 4.

The passive optical element 3 is at least substantially transmissive with respect to daylight. For example, the passive optical element 3 is configured to receive daylight from outside a structure and allow passage of light to an interior of the structure. The example shows the passive optical element 3 mounted in an exterior building structure 5, such as a roof or wall. Although there will be some losses as the light passes through the element 3 from the exterior or the interior space, the transmissivity of the element 3 is sufficient to provide useful illumination in the interior space, at least at times of bright daylighting outdoors. The passive optical element 3, for example, may be a transparent or translucent glass, acrylic or plastic member in the form or part of a window, a sun-room roof, or a skylight (or part of the skylight). The orientation shown in FIG. 1, might correspond to a roof mounted skylight or the roof of a sun-room or the like; although other orientations may be used for windows or the like. Although not shown in the simple illustration of the example, passive optical element 3 may be a transmissive section or component of a more sophisticated daylighting device that includes an optical collector, a channel, one or more reflectors and an optical distributor to supply and distribute natural light from outside the building to regions of the interior space.

The optical modulator 4 is associated with the passive optical element 3 so as to modulate light passively supplied through the optical element 3 for modulated emission into the interior of the structure. In the example, the modulator 4 is positioned so as to modulate light that the modulator 4 receives from the passive optical element 3; however, that arrangement is shown by way of example only. As another example, the optical modulator 4 may be located to modulate light before entry into the passive optical element 3. Stated another way, the optical modulator 4 may be adjacent to or mounted on the entry or exit surface(s) or both surfaces of the passive optical element 3. As another type of example, the optical modulator 4 may be integrated into the structure of the passive optical element 3.

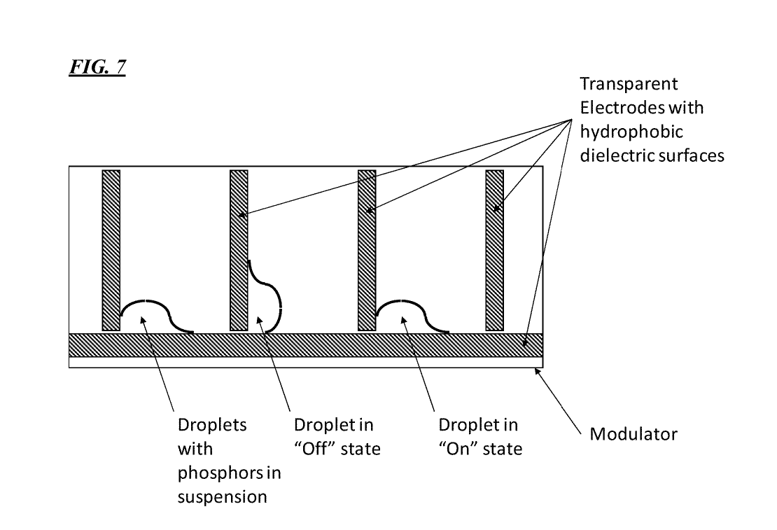

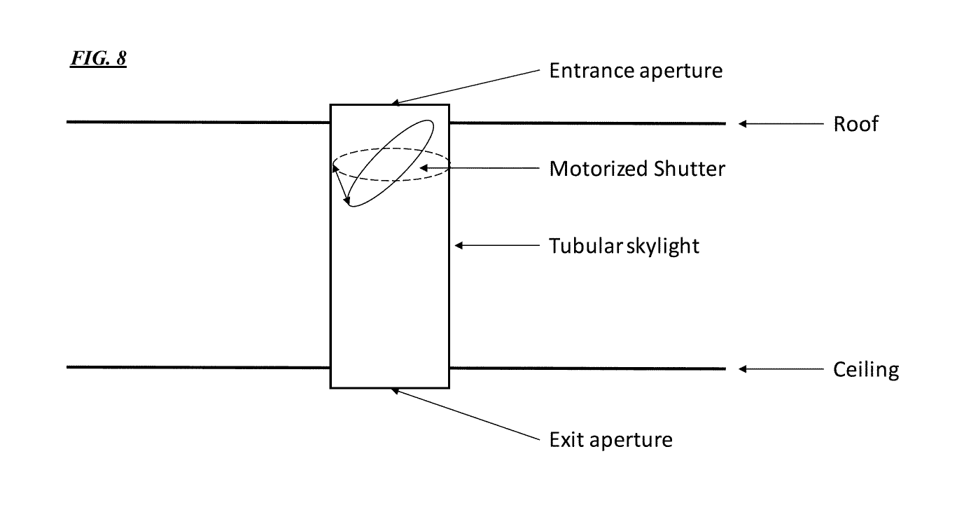

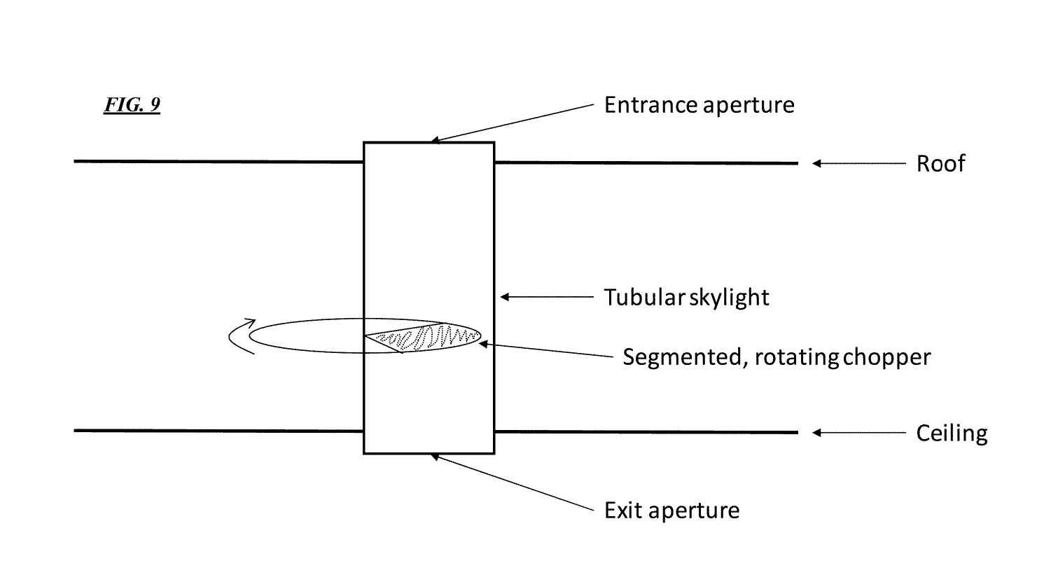

The modulator 4 is optical in that it modulates optical light energy that the modulator receives as light from a source of the light; as opposed to an electrical/electronic modulator that modulates operation of an artificial light generator, for example, by modulating a power supply drive signal or other control signal applied to the light generator. In the examples, the optical modulator 4 is configured to optically modulate light wavelengths in a range encompassing at least a substantial portion of the visible light spectrum. For example, some types of modulators may modulate ultraviolet light as well as some visible light in a range including near-ultraviolet in the visible spectrum and possibly some visible blue light. Other types of modulators may modulate just specific ranges within the visible spectrum, e.g. ranges of red, green or blue light. Still other optical modulator configurations may modulate 80% or more of the visible spectrum and/or may modulate the entire visible spectrum as well as some light in the infrared or ultraviolet ranges of the spectrum. Some modulators may shift a portion of the light energy from one portion of the spectrum to another portion of the spectrum (usually higher energy photons are converted to lower energy photons). An example of this would utilize a phosphor or quantum dot (QD)-based modulator as discussed more, later, with respect to FIG. 7.

The optical modulator 4 may be implemented using a variety of controllable optical element or devices, configured to vary one or more characteristics of light output in response to a control signal, e.g. in response to a data input signal. Different implementations of the modulator 4 may vary different characteristics of the light, such as overall intensity, intensity of particular wavelengths or frequency bands, polarization, or angular distribution. It may help to consider examples of technologies to control overall intensity.

By way of a first example, a general category of such an intensity control technology is switchable glass—sometimes referred to as smart glass. Switchable glass typically is implemented as a multi-layered structure of transparent and switchable materials. For example, a switchable layer may be sandwiched between two transparent layers of glass, plastic or the like. One state of the switchable material is transmissive relatively transparent; whereas, in another state, the switchable material exhibits low transmissivity, e.g. is opaque or translucent. Some switchable materials used in smart glass allow for transitional or intermediate states between the transmissive and light-blocking state, e.g. for dimming. Depending on the switchable glass product used to implement the optical modulator 4, the light modulation may involve switching between the transmissive state (light ON, e.g. 70% or more) and the light-blocking state (light at least substantially OFF, e.g. 10% or less); or the light modulation may involve switching between one or more of the ON/OFF states and one or more intermediate states (e.g. between four states such as ≤10%, 25-35%, 50-60% and ≥70%). Current switchable glass products utilize several different types of technologies for the switchable layer, such as: polymer dispersed or micro-blend liquid crystal (LC) devices, suspended particle device (SPD) electrochromic devices. These types of devices change states in response to an applied voltage. A variant uses a similar switchable layer in the form of a smart switchable film, which may be attached to a desired substrate such as a transparent (e.g. glass) window pane. Drawbacks of current examples of these switchable materials may be the need to apply the voltage to achieve the transmissive state (which may impact power consumption for modulated daylighting applications) and slow switching speed (which may not adequately support high data rate light-communication applications). The switchable glass example outlined above is just one example of a technology that may be used to implement an optical modulator. Other examples are described in detail later, with respect to FIGS. 7 to 12.

The system 1 also includes a controller 6, for controlling operations of the optical modulator 4 of one or more passive lighting devices 2. The controller 6 includes logic/processor circuitry coupled to control the optical modulator 4 to modulate data on the light emitted from the passive lighting device into the interior of the structure in a manner to minimize or prevent perception of the data modulation by an occupant in the interior of the structure. In the example, logic/processor circuitry is implemented by a processor circuit 7, such as a microcontroller or microprocessor, and associated logic circuitry 8, such as a memory device or other type storage for storing programming logic for execution by the processor circuitry 7 or data for processing by the processor 7.

Some variations of light are observable by occupants of an illuminated space, and some observable variations of light can be distracting or even disruptive of intended activities of occupants of the space. Hence, in the examples, the controller 6 is configured so as to control the optical modulator 4 to modulate data on the light emitted from the passive lighting device in a manner to minimize or prevent perception of the data modulation by an occupant in the interior of the structure. For example, one type of undesirable on and off variation is sometimes referred to as “directly visible flicker.” Most humans cannot see flicker above 60 Hz, but in rare instances some people can perceive flicker at 100 Hz to 110 Hz or even a bit higher. In light modulation of the type under consideration here, to mitigate against perception of the light modulation as “flicker,” the optical modulator 4 can be configured/controlled to modulate the light at a rate above 200 Hz. Another type of undesirable behavior is Stroboscopic flicker, which occurs at higher frequencies and can be made visible due to relatively rapid motion. An example is reading, where the eyes are moving across the page relatively quickly and there are high contrast items (letters against background). Stroboscopic flicker can be somewhat mitigated in the optical modulation under consideration here if the period and duty cycle of each consecutive on/off cycle of the modulation is not constant.

As noted, the optical modulator 4 may take the variety of forms, several of which are discussed later with respect to FIGS. 7 to 12. The controller 6 would take the form of or include processor controlled circuitry (not separately shown) configured to drive the particular type of optical modulator 4. There may also be differences in designs of controller 6 to support different modulation rates, e.g. for different types of visual light communication application.

Although the optical modulator 4 is driven to modulate the passive illumination entering the interior space via the optical element 3, and the associated controller 6 is powered to run its internal circuitry as well as to drive the operations of the modulator 4, the lighting device 2 is “passive” in that the light supplied to the illuminated interior area or space is collected and/or distributed, not generated by the device 2. Light generation does not involve consumption of electrical power by such a passive lighting device 2. If unmodulated, there may be no power consumption by the passive lighting device 2, for example if the optical modulator 4 and controller 6 are powered OFF. The optical modulator 4 and attendant controller 6 may be implemented by low power technologies to minimize power consumption by the system 1.

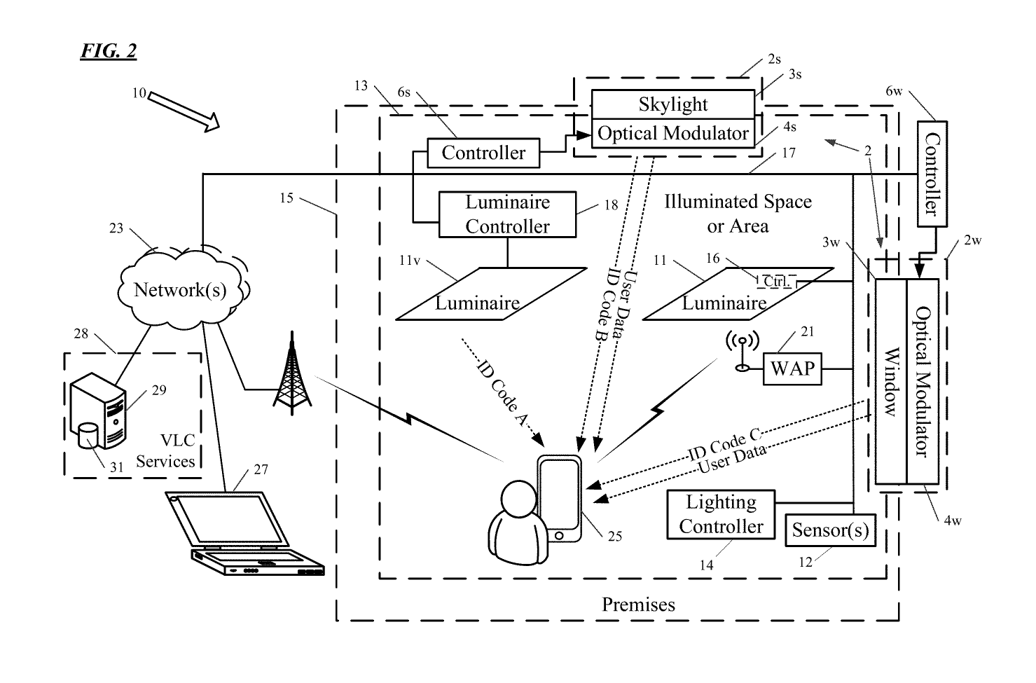

FIG. 2 is a simplified functional block diagram of an overall system 10 offering visual light communications using modulation of passive lighting from two examples 2s and 2w of modulated passive lighting device 2 (see also FIG. 1). As shown, the system 10 also includes regular luminaires 11, which are powered to provide artificial lighting. As discussed more later, one or more luminaires 11v are also controlled to modulate the artificial light output(s) thereof to support visual light communication. FIG. 2 also shows several types of other elements that may use or communicate with/through the visual light communication system 10.

The passive lighting device 2s or 2w, the luminaires 11, as well as some other elements of or coupled to the system 10, are installed within the space or area 13 to be illuminated at a premises 15. The premises 15 may be any location or locations serviced for lighting and other purposes by a system 10 of the type described herein. Most of the examples discussed below focus on indoor building installations, for convenience. Hence, the example of system 10 provides lighting and services utilizing visual light communication, in a number of service areas in or associated with a building, such as various rooms, hallways, corridors or storage areas of a building. Any building forming or at the premises 15, for example, may be an individual or multi-resident dwelling or may provide space for one or more enterprises and/or any combination of residential and enterprise facilities. A premises 15 may include any number of such buildings; and, in a multi-building scenario, the premises may include outdoor spaces and lighting in areas between and around the buildings, e.g. in a campus configuration. The system 10 may include any number of passive lighting devices 2 and any number of luminaires 11 arranged to illuminate each area 13 of the particular premises 15.

Although the modulated passive lighting devices 2 and luminaires 11 may operate and/or be controlled separately by any convenient means; in the example, control functions as well as some possible transport of information to devices 2 or 11 for light based communication utilize a data network 17 at the premises 15. Any suitable networking technology (communication media and/or protocol) may be used to implement the data network 17.

Like the device 2 in FIG. 1, each example 2s or 2w of a passive lighting device in FIG. 2 includes a passive optical element 3s or 3w and an associated optical modulator 4s or 4w. Although not shown, there may be additional passive lighting devices that do not have modulators. For discussion purposes, passive optical element 3s is a passive element of a skylight, whereas the passive optical element 3w is a passive element of a window. Also, in this example, the optical modulator 4s is associated with an output of the corresponding passive skylight element 3s, whereas the optical modulator 4w is associated with an input of the corresponding passive window element 3s. As noted earlier, however, the optical modulator may be coupled to either input or output or included within the structure of the passive element(s) of any type of passive lighting device 2.

Each modulated passive lighting device 2s or 2w is controlled by a respective controller 6s or 6w. The controller 6s includes logic/processor circuitry coupled to control the optical modulator 4s, and the controller 6w includes logic/processor circuitry coupled to control the optical modulator 4w. In the example of FIG. 2, each controller controls the respective optical modulator 4 to modulate data on the light emitted from the respective passive lighting device into the interior space or area 13 of the structure at premises 15. Although shown as two separate controllers 6s, 6w, the functions thereof could be implemented in a single control device coupled to control two or more modulated passive lighting devices 2. As shown by the arrows in FIG. 2 Each passive lighting device 2s or 2w may provide modulated light output a device identification (ID) code, for example, for an indoor mobile positioning and/or location based service. As another alternative, each passive lighting device 2s or 2w may provide modulated light output user data, e.g. as received from a network via the interface, on the light emitted from the passive optical element into the interior area 13 of the structure. Such user data can be any data intended for reception and possibly further processing by a user device in the premises, for example, a portable handheld (e.g. mobile) device 25. The modulator and/or the configuration of the associated controller may be different for these different types of visual light communication, e.g. to provide different types and rates of data communications for those different types of visual light communication.

Each controller 6s or 6w could be a standalone device preset or pre-programmed with the data or other information (e.g. an identification code) that is to be modulated on the passive light that the device 2s or 2w supplies into the interior space 13. In the example, however, each controller 6s or 6w is a relatively intelligent controller connected to the data network 17, for additional communications and control functions.

The system elements, in a system like system 10 of FIG. 2, may include any number of luminaires 11 for artificial lighting as well as one or more lighting controllers 14, for each illuminated area 13 of the premises 15. Lighting controller 14 may be configured to provide control of lighting related operations (e.g., ON/OFF, intensity, brightness, color characteristic) of any one or more of the luminaires 11. That is, lighting controller 14 may take the form of a switch, a dimmer, or a smart control panel including a user interface depending on the functions to be controlled through device 14. The lighting system elements may also include one or more sensors 12 used to control lighting functions, such as occupancy sensors or ambient light sensors. Other examples of sensors 12 include light or temperature feedback sensors that detect conditions of or produced by one or more of the lighting devices. If provided, the sensors may be implemented in intelligent standalone system elements such as shown at 12 in the drawing, or the sensors may be incorporated in one of the other system elements, such as one or more of the passive lighting devices 2 or the luminaires 11 and/or the lighting controller 14.

In the example, one or more of the luminaires 11 are regular artificial lighting devices controlled to provide illumination, with the control communications to/from the appropriate lighting controller 14 and/or sensor 12 implemented via the data network 17 at the premises. Hence, in the example, regular luminaires include a network connected controller (Ctrl.) 16. By way of example, the luminaires 11 (with controllers 16), the sensor(s) 12, the lighting controller(s) 14, and the data network 17 may be implemented as disclosed in US Patent Application Publication No. 2014/0252961 by Ramer et al. and/or in US Patent Application Publication No. 2015/0043425 by Aggarwal et al., the entire contents of both of which are incorporated herein by reference.

In the example, one or more of the modulated luminaires 11v has an associated controller 18. In addition to responding to state control communications from a lighting controller 14 and/or a sensor 12, in a manner similar to the control function of the regular luminaire 11, the controller 18 controls operation of the modulated luminaire 11v to modulate the light output thereof to represent or carry information/data. Although shown separately for convenience, the controller 18 may be incorporated into the physical structure implementing or housing the light source of the modulated luminaire 11v.

As outlined above, the on-premises system elements such as 6s, 6w, 12, 16, 18 and 19, in a system like system 10 of FIG. 2, are coupled to and communicate via a data network 17 at the premises 15. The data network 17 in the example also includes a wireless access point (WAP) 21 to support communications of wireless equipment at the premises. For example, the WAP 21 and network 17 may enable a user terminal for a user to control operations of any lighting device 11 at the premises 13. Such a user terminal is depicted in FIG. 1, for example, as a mobile or other portable handheld type device 25 within premises 15, although any appropriate user terminal may be utilized. However, the ability to control operations of a lighting device 11 may not be limited to a user terminal accessing data network 17 via WAP 21 or other on-premises access to the network 17. Alternatively, or in addition, a user terminal such as laptop 27 located outside premises 15, for example, may provide the ability to control operations of one or more lighting devices 11 and/or controller 6s or 6w via one or more other networks 23 and the on-premises network 17. Network(s) 23 includes, for example, a local area network (LAN), a metropolitan area network (MAN), a wide area network (WAN) or some other private or public network, such as the Internet.

For lighting operations, the system elements for a given service area (6s, 6w, 12, 16, 18 and 19) are coupled together for network communication with each other through data communication media to form a portion of a physical data communication network 17. Similar elements in other service areas like 13 of the premises 15 are coupled together for network communication with each other through data communication media to form one or more other portions of the physical data communication network 17 at the premises 15. The various portions of the network in the service areas in turn are coupled together to form a data communication network at the premises, for example to form a LAN or the like, as generally represented by network 17 in FIG. 2. Such data communication media may be wired and/or wireless, e.g. cable or fiber Ethernet, Wi-Fi, Bluetooth, or cellular short range mesh; and the network 17 may support one or more communication protocols suitable for or specifically adapted to the particular media implementing the network 17. In many installations, there may be one overall data communication network 17 at the premises. However, for larger premises and/or premises that may actually encompass somewhat separate physical locations, the premises-wide network 17 may actually be built of somewhat separate but interconnected physical networks utilizing similar or different data communication media and protocols.

In the example, the overall system 10 also includes server 29 and database 31 accessible to a processor of a computer programmed as the server 29. Such a computer, for example, typically includes the processor, a network communication interface and storage coupled to be accessible to the processor. The storage can be any suitable hardware device (and use any suitable protocol) that stores the sever programming for execution by the processor, to configure the computer as server 29. The storage may also contain the database 31, or the database may reside in other storage, e.g. on a hardware platform coupled to the computer or coupled for communication with the computer running the server programming through a network.

Although FIG. 2 depicts server 29 as located outside premises 15 and accessible via network(s) 23, this is only for simplicity and no such requirement exists. Alternatively, server 29 may be located within the premises 15 and accessible via network 17. In still another alternative example, server 29 may be located within any one or more system element(s), such as lighting device 11, lighting controller 19 or sensor 12. Similarly, although FIG. 2 depicts database 31 as physically proximate server 29, this is only for simplicity and no such requirement exists. Instead, database 31 may be located physically disparate or otherwise separated from server 29 and logically accessible by server 29, for example, via network 17.

Communication with the server 29 and database 31 can support operations of the system elements at the premises 15, e.g. for monitoring and/or automated control of lighting. For purposes of the present discussion, however, the server 29 and database 31 may be involved in one or more ways with the visual light communication operations of the system 10, including the light communications via the passive optical devices 2. The same or other network equipment may also monitor and control aspects of the light communication operations, e.g. to identify devices using light communication services, determine amount of usage of the services, and/or control ID codes or other aspects of the light based communication transmissions from the devices 2 and 11v. Several other examples of communication with the server 29 and/or database 31, in relation to visual light communication operations of the system 10, are discussed below; and for those discussions, the server 29 and database 31 are collectively identified as VLC services 28 in FIG. 2.

In an application providing indoor position determination and/or related location based information, for example, a mobile device 25 includes a light sensor and is programmed or otherwise configured to demodulate lighting device ID codes from a signal from the light sensor. In a typical mobile device example, the included light sensor is an image sensor, such as a camera (e.g. a rolling shutter camera or a global shutter camera). In such a mobile device 25, the programming for the processor configures the device 25 to operate the image sensor to capture one or more images that include representations of at least one modulated passive optical device 2 and/or at least one modulated luminaire 11v and to process data or other signal of the image(s) to demodulate one or more lighting device ID codes from the captured image(s). In such an image sensor based example, the image processing to recover ID codes captures one or more such codes which may have been sent by a modulated passive lighting device 2 and/or a modulated luminaire 11v in the vicinity of the device 25. The relevant modulated light content, e.g. from a particular device 2 or 11v, in any captured image depends on the position and orientation of the mobile device 25 and thus of its image sensor at the time of image capture.

One or more lighting device ID codes obtained from processing of the captured image(s) may then be used in a table lookup in the database 31 (or in a portion of the database downloaded previously via the network(s) 23 to the mobile device 25), for a related mobile device position estimation and/or for information retrieval functions. For example, the mobile device 25 may use its inherent RF wireless communication capabilities to communicate through the network(s) 23 for assistance in a precise position estimation based on one or more lighting device ID codes alone or in combination with mobile device orientation data. As another example, the mobile device 25 may use its inherent RF wireless communication capabilities to communicate through the network(s) 23 to obtain other position or location related services such as routing instructions or product or service promotions related to estimated mobile device position. Alternatively, the position estimation or retrieval of information for location related services may utilize a smaller relevant subset of the database 31 corresponding to all or part of a particular premises 15, which was downloaded to the mobile device via an earlier network communication prior to image capture, e.g. upon entry to the area 13 or the particular premises 15.

Indoor positioning systems have been developed that rely on ID codes of modulated luminaires like 11v; and in such systems, the database maps the stored ID codes to position estimation information and/or other location-related information. Examples of such systems are disclosed in US Patent Application Publication No. 2013/0141554 to Ganick et al. and US Patent Application Publication No. 2015/0147067 to Ryan et al., the entire contents of both of which are incorporated herein by reference. The database 31 in the system 10 may include similar information but also includes ID codes of the modulated passive lighting devices 2 and maps those additional codes to similar corresponding position estimation information and/or other location-related information corresponding to locations of modulated passive lighting devices 2.

Hence, in the examples, it is possible to determine an ID code of the passive lighting device 2 obtained from modulated light transmitted by the passive lighting device. With the enhanced database 31 or a relevant portion thereof, it is possible to retrieve the record for the passive lighting device 2, based on the ID code of the passive lighting device. If a portion of the database has been downloaded to the mobile device 25, the mobile device 25 can estimate its position or can forward the ID to VLC services 28 to obtain an estimate of position. In either case, the system 10 processes location-related information from the record for the passive lighting device 2. As an alternative or in addition to position estimating, the processing may involve delivery to the user of other location-related information such as map position, advertisements about products or services in the vicinity, special offers about such products or service localized access (e.g. door entry when the correct device 24 comes within a certain distance of the door), etc.

The inclusion of the database 31, however, also supports similar functions/services based on an ID code from a modulated luminaire 11v, alone or in combination with the use of the code from the passive lighting device 2. For example, the system may additionally determine an ID code of a luminaire 11v obtained from modulated light transmitted by the luminaire 11v, and based on the ID code of the luminaire, retrieve the record for the luminaire. At times when an image only captures light from a modulated luminaire 11v, further processing of location-related information from the record for the luminaire may be based only on one or more such luminaire ID codes. In other cases, the image processing may capture representations of both a modulated luminaire 11v and a modulated passive lighting device 2, and the attendant processing may involve processing location-related information from the records for both the luminaire 11v and the device 2.

As another example of light based communication via the system 10, if the networks and visual light communication capabilities provide a high enough data rate, the server 29 may send user data over the 23 and 17 to one or more of the controllers 6 or 19 to modulate the data onto light output from a modulated passive device 2 or a modulated luminaire 11v, for reception by a user terminal device such as mobile device 25. Upstream communications from the user's mobile device 25 may use uplink light communication elements not shown or may use the wireless communication capability of the device 25, e.g. via the wireless access point 21 or a cellular network tower coupled to the network(s) 23.

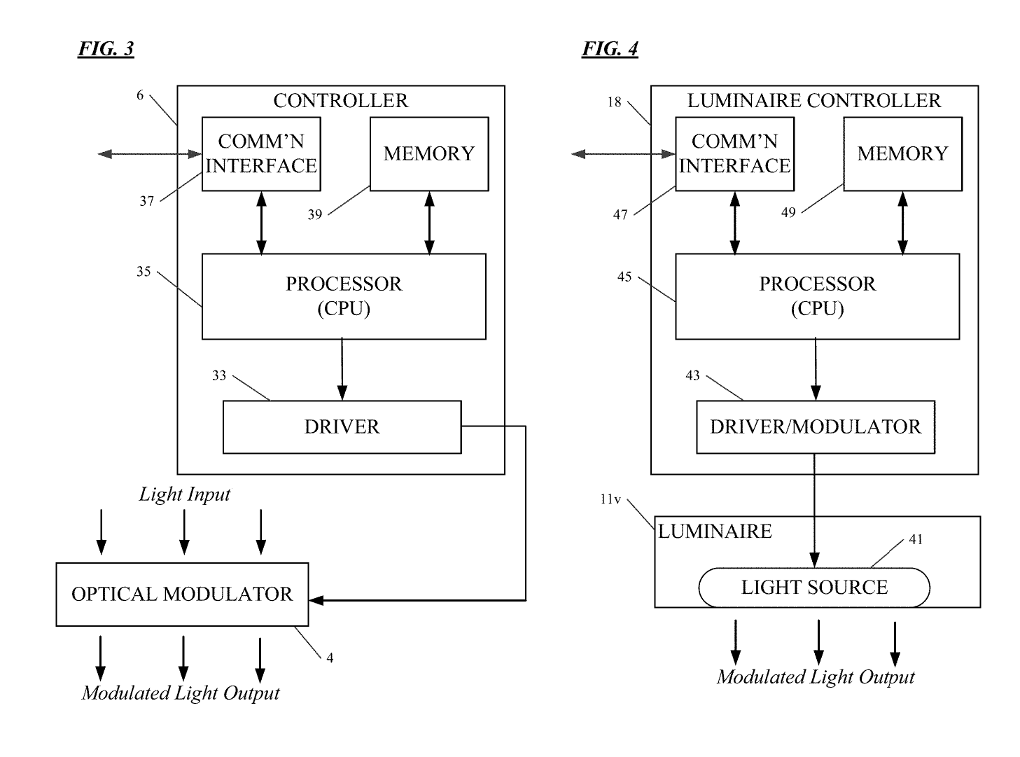

FIG. 3 is a simplified functional block diagram of controller 6 and an associated optical modulator 4 for use in/with a daylighting device, such as one of the passive lighting devices 2 of FIG. 1 or FIG. 2.

The controller 6 for a modulator 4 associated with a passive optical element 3 of a lighting device 2 (FIGS. 1, 2) includes a suitable driver circuit 33 for operating the particular type of electronically controllable optical device that is used to implement the modulator 4. Depending on the modulator circuitry, the driver circuit 33 provides any operating power that may be necessary and provides any control signals (if separate from the driver signals) used to implement the selected type of modulation in accordance with the information to be transmitted via light.

The example of a controller 6 includes a processor 35 coupled to control the diver circuit 33 and thus the modulator 4. The processor 35 also is coupled to communicate via a communication interface 37, which in this example provides communications functions for sending and receiving data via the network 17 shown in FIG. 2. The particular type of interface 37 depends on the media and/or protocol(s) of the applicable network 17 at the premises.

The processor 35 is an electronic circuit device configured to perform processing functions like those discussed herein. Although the processor circuit may be implemented via hardwired logic circuitry; in the examples, the processor 35 is a programmable processor such as a programmable central processing unit (CPU) of a microcontroller, microprocessor or the like. Hence, in the example of FIG. 3, the controller 6 also includes a memory 39, storing programming for execution by the CPU circuitry of the processor 35 and data that is available to be processed or has been processed by the CPU circuitry of the processor 35.

The processor 35 and memory 39 and possibly the communication interface 37 may be separate hardware elements as shown; or the processor 35 and memory 39 and possibly the communication interface 37 may be incorporated together, e.g. in a microcontroller or other ‘system-on-a-chip.’ Alternatively, the processor 35 and memory 39 and possibly the communication interface 37 may be incorporated in the circuitry of (e.g. on the same chip as) the driver 33.

The processors and memories in controllers 6 for the passive lighting devices 2 may be substantially the same throughout the system 10 of FIG. 2 at a particular premises 15. Alternatively, different controllers 6 for the passive lighting devices 2 may have different processors 35 and/or different amounts of memory 39, depending on differences of intended or expected processing functions at various locations.

In the example, each controller 6 has the processor 35, memory 39, programming and data set to implement the desired visual light based communications. In an indoor positioning application, for example, the programming would enable the processor 35 to communicate through the interface 37 and network 17, 23 (FIG. 2) with a commissioning or management server, e.g. to receive an assigned ID code. In the indoor positioning application example, programming would enable the processor 35 to control driver 33 and thus the modulator 4 to modulate the light passively supplied through the optical element for modulated emission into the interior of the structure, to thereby broadcast the assigned ID code in the area illuminated by the particular passive lighting device 2.

The controller 6 also may receive data via the network(s) and the interface 37 for communication to user devices like 25 via the visual light communication capabilities of the controller 6 and the passive lighting device 2 (FIGS. 1 and 2). In such a case, the programming would enable the processor 35 to process received data as may be appropriate and forward the received data as control signals for the driver 33. The signals thus supplied to the driver 33 cause driver 33 to operate the modulator 4 according to the processed data and thereby modulate the output of the passive lighting device into the area illuminated by the passive lighting device 2.

Returning to the specific examples, the intelligence (e.g. processor 35 and memory 39), the communications interface 37 and the driver 33 are shown as elements separate from the modulator 4 (and passive optical element 3). Alternatively, some or all of the elements of the controller 6 may be integrated with either one or both of the elements 3, 4 of the passive lighting device 2.

As outlined above, the processor 35 controls the modulator 4 via the driver 33 to vary one or more characteristics of the light supplied by a passive lighting device to illuminate a particular space; and that modulation provides visual light communication, e.g. of a device ID and/or other information such as data intended for a user device, such as a mobile device 25, in the particular space. The processor 35, the driver 33 and/or the optical modulator 4 may be configured to implement any of a variety of different light modulation techniques. The controlled operation of the modulator 4, for example, may vary intensity, color characteristics of passive illumination and/or possibly even a pattern of characteristics of light across the output of the illumination device into the illuminated space. A few examples of specific light modulation techniques that may be used include amplitude modulation, optical intensity modulation, amplitude-shift keying, frequency modulation, multi-tone modulation, frequency shift keying (FSK), ON-OFF keying (OOK), pulse width modulation (PWM), pulse position modulation (PPM), ternary Manchester encoding (TME) modulation, and digital pulse recognition (DPR) modulation. Other modulation schemes may implement a combination of two or more of these modulation techniques.

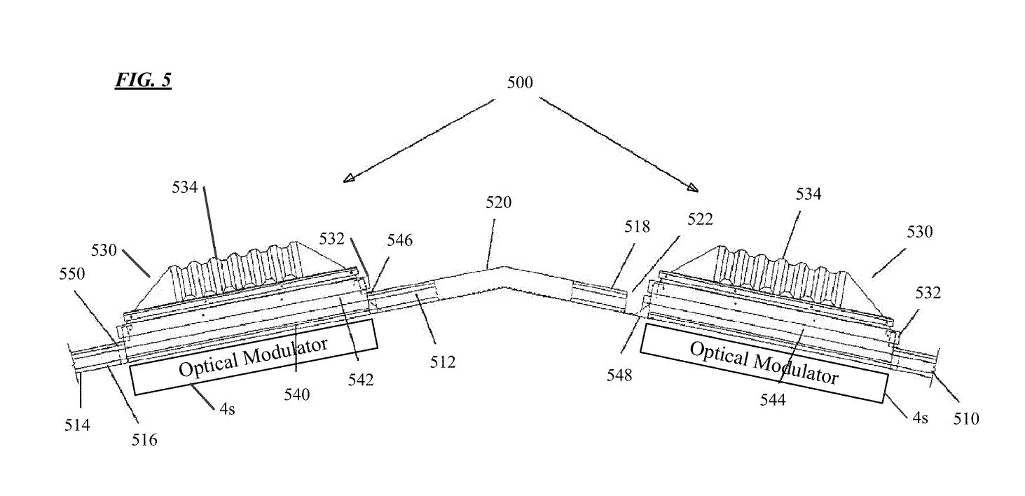

FIG. 4 is a simplified functional block diagram of general lighting luminaire 11v, together with an associated controller 18. The luminaire 11v, for example, includes a light source 41; and the luminaire controller 18v includes a suitable driver circuit 43 for providing power to the light source 41. For example, if the light source 41 is a light emitting diode (LED) based source (including one or more LEDs), the driver 43 would be a driver circuit configured to convert available AC (or possibly DC) power to current to drive the number of LEDs in the source 41. Of course other types of light sources and corresponding driver circuits may be used. In this example, the circuit 43 is also of a type capable of modulating the drive power supplied to the light source 41 to modulate the light output from the source 41.

The luminaire controller 18v includes a processor 45 coupled to control the light source operation via the driver/modulator circuit 43. The processor 45 also is coupled to communicate via a communication interface 47, which provides a communications functions for sending and receiving data via the network 17 shown in FIG. 2. The particular type of interface 47 depends on the media and/or protocol(s) of the applicable network 17 at the premises.

The processor 45 is an electronic circuit device configured to perform processing functions like those discussed herein. Although the processor circuit may be implemented via hardwired logic circuitry, in the examples, the processor 45 is a programmable processor such as a programmable central processing unit (CPU) of a microcontroller, microprocessor or the like. Hence, in the example of FIG. 4, luminaire controller 18v also includes a memory 49, storing programming for execution by the CPU circuitry of the processor 45 and data that is available to be processed or has been processed by the CPU circuitry of the processor 45. The processors and memories in controllers 18 for the modulated luminaires 11v may be substantially the same throughout the system 10 of FIG. 2 at the premises 15, or different controllers 18 may have different processors 45 and/or different amounts of memory 49, depending on differences in intended or expected processing needs for luminaires at different locations throughout the premises 15.

In the example, each luminaire controller 18 has the processor 45, memory 49, programming and data set to implement regular luminaire control as well as desired visual light based communications. In an indoor positioning application, for example, the programming would enable the processor 45 to communicate through the interface 47 and network 17, 23 (FIG. 2) with a commissioning or management server, e.g. to receive an assigned ID code. In the indoor positioning application example, programming would enable the processor 45 to control driver/modulator 43 to modulate power supplied to the light source 41 with the assigned ID and thus modulate the output of the light source 41 to thereby broadcast the assigned ID code in the area illuminated by the luminaire 11v.

The controller 18 also may receive data via the network(s) and the interface 47 for communication to user devices via the visual light communication capabilities of the controller 18 and luminaire 11v. In such a case, the programming would enable the processor 45 to process received data, as may be appropriate, and forward the received data as control signals for the driver/modulator 43. The signals thus supplied to the driver/modulator 43 cause driver/modulator 43 to modulate power supplied to the light source 41 according to the processed data and thereby modulate the output of the light source 41 to broadcast the data on the modulated light output of the light source 41 into the area illuminated by the luminaire 11v.

Returning to the specific examples, the intelligence (e.g. processor 45 and memory 49), the communications interface 47 and the driver 43 are shown as elements of a separate device or component coupled and/or collocated with the luminaire 11v containing the actual light source 41. Alternatively, some or all of the elements of the luminaire controller 18 may be integrated with the other elements of the luminaire or attached to the fixture or other element that incorporates the light source. As another example, the processor 45, the memory 49 and possibly even the interface 47 may be integrated on the chip that carries the circuitry of the driver 43.

As outlined above, the processor 45 controls the modulator function of the driver circuit 43 to vary the power applied to drive the light source 41 to emit light. This control capability may allow control of intensity and/or color characteristics of illumination that the light source 41 provides as output of the luminaire 11v. Of note for purposes of discussion of position system operations or other visual light communication applications, this control capability causes the driver/modulator 43 to vary the power applied to drive the light source 41 to cause modulation of light output of the light output of the source 41, including modulation to carry a currently assigned lighting device ID code from storage in memory 49 or with other data, e.g. as may be received via the network(s) through the communication interface 47. The processor and/or modulator may be configured to implement any of a variety of different light modulation techniques. A few examples of light modulation techniques that may be used include amplitude modulation, optical intensity modulation, amplitude-shift keying, frequency modulation, multi-tone modulation, frequency shift keying (FSK), ON-OFF keying (OOK), pulse width modulation (PWM), pulse position modulation (PPM), ternary Manchester encoding (TME) modulation, and digital pulse recognition (DPR) modulation. Other modulation schemes may implement a combination of two or more of these modulation techniques.

The present light communication concepts may be implanted by use of an optical modulator in or in combination with a wide variety of different types of passive lighting devices. It may be helpful to consider some examples of types and structures of suitable passive lighting devices.

FIG. 5 shows a system 500 including two skylights 530 with associated modulators 4s. The controller or controllers for the modulators 4s are omitted for convenience but could be implemented in a manner similar to controllers discussed above. The drawing also shows a rail mounting system adapted to attach the example skylights 534 to a standing seam panel roof 510. Of course, other mounting systems may be used to attach these or other types of skylights 534 to a roof or the like; and/or the illustrated rail mounting system may be used to attach one or more skylights 534 to the major structural elements of any type of roof. Also, the orientations of the skylights 534 are shown by way of examples only, and one or more skylights 534 may be mounted at other orientations dependent on the different roof profiles desired for particular building structures. The skylights 530 and associated rail mounting in the example of FIG. 5 are described in greater detail in U.S. Pat. No. 8,793,944 to Blomberg et al., the entire contents of both of which are incorporated herein by reference.

In the example of FIG. 5, the standing seam metal panel roof 510 has raised rib or rib elevations 512 and a panel flat 514 extending between the rib elevations. Each rib elevation includes a raised shoulder 516 and standing seam 518. Also depicted is the ridge cap 520 of the metal panel roof. The system 500 includes skylights 530, each of which includes a skylight frame 532 and skylight lens 534. While the drawing shows a lens 534 of a particular profile shape, which may correspond to a rectangular lateral perimeter, it will be understood that each skylight may use a lens of that or a different shape suitable for a particular passive lighting application and/or building aesthetic.

The rail mounting system 540 in the example is configured to prevent water intrusion through the sides of the skylight and rail mounting system. The rail mounting system 540 includes side rails 542 and 544. An upper diverter 546 is disposed between and adjacent rib elevations 512 of the metal panel roof 510 at the top ends of the side rails 542, 544. A rib cutaway region, or gap 522, in one of the rib elevations 512 is provided the top end of the side rails so that water can be diverted by diverter 546 onto an adjacent roof panel. A plate 548 may be located under the gap 522 to prevent water leakage through the roof. A low end closure 550 may be provided between the rib elevations 112 at the bottom ends of side rails 542, 544 to prevent water intrusion at this end of the skylight and rail mounting system.

In the example, each optical modulator 4s is mounted adjacent to the interior optical aperture of the respective skylight 530 into the interior space below the roof 510. For example, each optical modulator 4s may be hung from the lower, interior edges of frame rail(s) forming the box frame of the mounted skylight 530. Alternatively, each optical modulator 4s may be mounted within the box frame of the respective mounted skylight 530, closer to or adjacent to the lower edges of the lens 534 of the respective skylight 530. Other mounting options and/or positions of each of the optical modulator 4s may also be feasible. The size of the optical modulator 4s, e.g. in proportion to the size of skylights 530, is chosen to make illustration of the modulators easy to see in the drawing and is not representative of actual size or proportions of the modulators, the skylights or any elements thereof. For example, each modulator may be implemented as a thin film on a transparent substrate of or attached to the skylight and therefore difficult to distinguish as a separate component in a side elevation view such as depicted in FIG. 5.

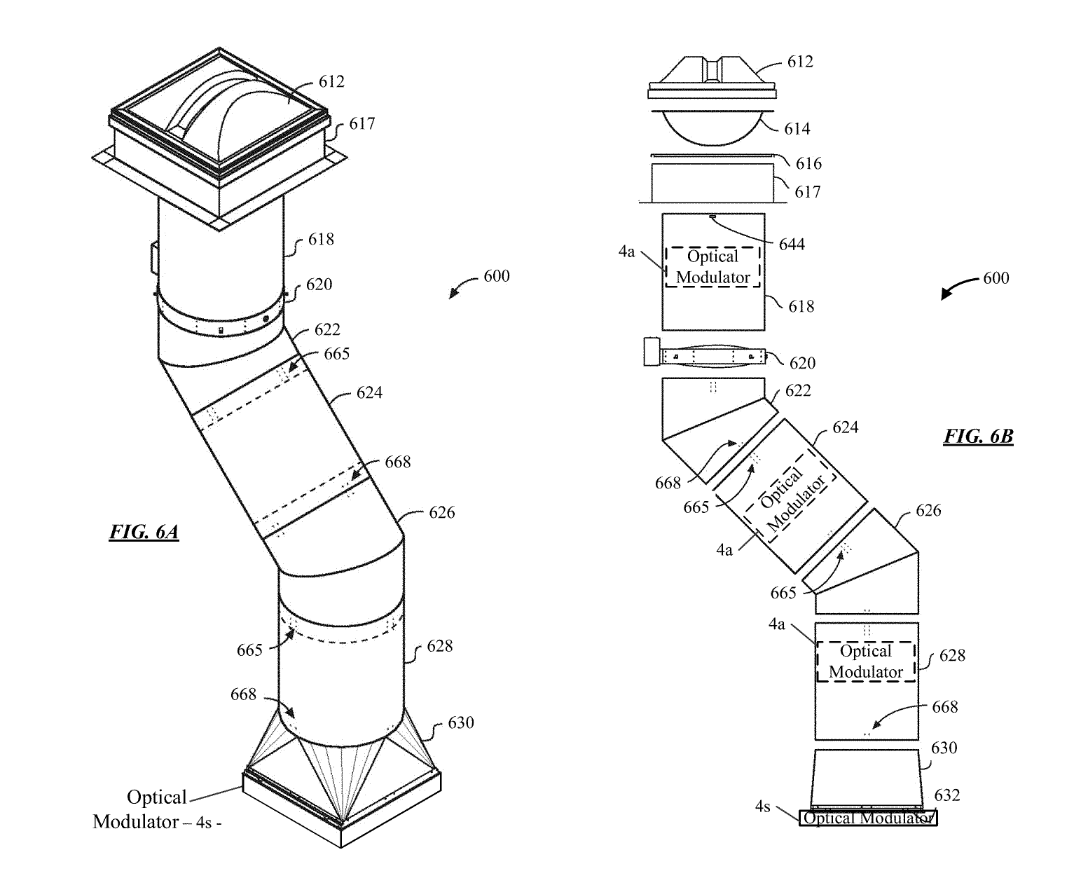

As another example of a suitable passive lighting device, FIGS. 6A and 6B shows a tubular prismatic skylight 600 and an associated optical modulator 4s. FIG. 6B also show implementation of the optical modulator at several examples of alternate locations indicated by numeral 4a, e.g. within various sections of the tubular prismatic skylight 600. The controller for the modulator 4s or 4a is omitted for convenience but could be implemented in a manner similar to controllers discussed above. The tubular prismatic type skylight 600 in the example of FIGS. 6A and 6B is described in greater detail in US Patent Application Publication No. 2013/0314795 to Weaver, the entire contents of both of which are incorporated herein by reference.

The passive lighting device 600 is implemented as a tubular daylighting system. The device 600 includes a skylight lens 612, a diffuser 614, a square-to-round transition plate 616, a square curb piece 617, and an upper straight tubular shaft section 618. The passive lighting device 600 also includes a light damper 620, an upper angled tubular shaft section 622, a middle straight tubular shaft section 624, a lower angled tubular shaft section 626, and a lower straight tubular shaft section 628. The device 600 further includes a round-to-square transition piece 630 and a hinging troffer bracket 632. The tubular shaft sections 618, 622, 624, 626, 628 have reflective interior surfaces. The passive lighting device 600 takes light gathered by the skylight lens 612 and transmits the collected light through the system to a ceiling diffuser secured to the ceiling using the hinging troffer bracket 632.

When installed, the square curb piece 617 is incorporated into the roof structure of a building or the like at the premises, and the square-to-round transition plate 616 is mounted on the top side of the square curb piece 617. Upper straight shaft section 618 is suspended from transition plate 616 by inserting inwardly extending tabs provided in circular aperture of the transition plate 616 into slots 644 provided in the upper edge of shaft section 618.

The light damper 620 includes a circular light blocking plate rotatably attached to the inside of circular wall of the damper via a pivot pin. The pivot pin extends from and may be controlled by a motor not shown. The orientation of plate within the wall of the damper 620 can be controlled by rotation of pivot pin, through selective operation of the motor. The damper plate can be rotated to a horizontal disposition in which it blocks light entering the skylight 612 from being transmitted below light damper 620. If damper plate is oriented to a vertical position, virtually all the light collected by the skylight 612 is transmitted below light damper 620.

Upper angled shaft section 622 is suspended from the light damper 620 with threaded fasteners thereby providing an upper bend in the system 600.

The middle straight shaft section 624 is attached to and depends from the upper angled shaft section 622 using a tab and slot interconnection. A number of tabs are formed in an array 665 in the top part of the straight shaft section 624. A number of such arrays 665 of tabs are circumferentially distributed around the top end of the shaft section. A corresponding number of sets 668 of slots are provided on the bottom end of the angled shaft section 622. Similar arrays 665 of tabs are provided at the lower ends of other sections 626 and 628, and matching sets 668 of slots are provided at the upper ends of other sections 626 and 628. The shaft sections are provided in two alternating diameters, one diameter being slightly smaller than the other so that one section with a smaller diameter will fit snugly within an adjoining section having a larger diameter in a nesting configuration. Thus, adjoining shaft sections may fit into each other by alternating small and large diameter shaft sections. Each set 668 of slots is angularly aligned with one of the arrays 665 of tabs such that each slot of a top shaft section registers with one of the tabs of a bottom shaft section of two sections that are being interconnected.

Where the system output is located within the interior space of the building structure, the round-to-square transition piece 630 shown in the drawings is attached to the lower straight shaft section 628. A hinging troffer bracket 632 is attached to the round-to-square transition piece and a ceiling diffuser (not shown) is secured to the troffer bracket 632 so that by swinging down troffer bracket 632 the ceiling diffuser is made accessible for ease of cleaning.

The drawings (FIGS. 6A and 6B) show an arrangement in which the optical modulator 4s is mounted adjacent to the interior output of the tubular prismatic skylight, for example, adjacent to the ceiling diffuser secured to the troffer bracket 632. Similar to the earlier examples, however, an optical modulator may be mounted at other locations in or around the passive optical lighting device, in this case, at various points on, around or within the tubular prismatic skylight. FIG. 6B therefore shows several alternative examples of optical modulators 4a mounted within different tubular shafts of the tubular prismatic skylight. Although not shown, the optical modulator may be implemented on or in association with the skylight lens 612 or the diffuser 614; and still other locations in or around the elements of the skylight may be suitable, e.g. for particular types of optical modulators and/or for efficacious appearance or operation. As further examples, the optical modulator may be incorporated into the reflective surfaces of the tube of the skylight. In such an implementation, modulation of the light would occur through changes in the effective reflectivity of the tube walls. If the reflective walls work using Total Internal Reflection (TIR), it may be practical to modulate reflectivity by moving a scattering or absorbing material in and out of optical contact with the TIR surface(s). If the material is a specular reflector, e.g. metallic or multi-layer film, then modulation may occur through a thin film modulator on the inside surface. The modulator could use a change in scattering or an electrochromic change (e.g. similar to an automatic day/night function of a car rearview mirror) as examples.

The size of the optical modulator 4s or 4a, e.g. in proportion to the size of skylight components, is chosen to make illustration of the modulators easy to see in the drawings and is not representative of actual size or proportions of the modulators, the skylight or any elements thereof. For example, each modulator may be implemented as a thin film on a transparent substrate and therefore difficult to distinguish as a separate component in view like those shown in FIGS. 6A and 6B.

As noted earlier, there a variety of technologies that may be used to implement the optical modulator associated with or incorporated in the device, to modulate light supplied to an interior space to carry data. It may be helpful now to consider now several more specific examples, with reference to representative drawings.

FIG. 7 depicts a phosphor or quantum dot (QD) and electrowetting-based optical modulator. A phosphor or quantum dot is a type of lumiphor material that produces a wavelength conversion of light. The lumiphor absorbs light of its excitation wavelength and re-emits light of a converted or shifted wavelength. At a conceptual level, this type of lumiphor-based modulation works by changing the amount of phosphor or QD type material that is exposed to the incident light and therefore changes how much the spectrum of the output light is changed by the selective amount of wavelength shifting produced by the lumiphor. The concept is that if the spectrum was changed quickly enough and the detector was sensitive to this change, then it may be feasible to use the spectral color shift to encode the data in the same way as we use intensity in earlier examples. The modulator of FIG. 7 uses electrowetting to vary the amount of exposed phosphor or QD type material and thus the magnitude of light that is shifted in wavelength.

In the example of FIG. 7, a series of cells are designed to implement a version of electrowetting. Electrowetting is a fluidic phenomenon that enables changing of the configuration of a contained fluid system in response to an applied voltage. In general, application of an electric field modifies the wetting properties of a surface (e.g. ability of liquid to maintain physical contact with a hydrophobic surface) in the fluid system. When a liquid is in contact with a surface, and that surface becomes charged, the electric field tends to either pull the mass of an electrically conductive liquid down towards the surface or repel it up away from the surface. This phenomenon enables controlled changes the overall distribution and shape of the liquid with respect to the surface responsive to changes of the voltage(s) applied to change the electric field.

The drawing shows a single fluid implementation in each cell, although many electrowetting optics use two immiscible fluids, one insulating and one conductive. The modulator of FIG. 7 therefore includes a drop of the liquid in each cell. The array of cells includes a horizontal transparent electrode and transparent vertical electrodes defining the cell boundaries. On some or all of the surfaces that may contact the fluid, the electrodes may be coated with a hydrophobic dielectric. Fluid containment elements of the array are omitted for ease of illustration.

In the example of FIG. 7, the phosphors (or quantum dots, etc.) are suspended in a liquid in the various cells of the array. The electrowetting array implementation of the optical modulator would be mounted inside or in association with the daylighting device. Although the daylighting device is omitted for convenience, the drawing shows a horizontal orientation of the array, as might be used, for example, to extend across a vertical tube of the daylighting device. In such an arrangement/orientation, light passing through the daylighting device would pass vertically through the illustrated optical modulator. Modifying the voltage applied across the droplet of liquid in each cell changes the shape and/or location of the drop in each of the cells. This voltage responsive shape change of the droplets changes how much light is converted by the lumiphor. The example does this by moving the droplet away from the center of each cell in the “off” state and moves it towards the middle in the “on” state. The droplet in the center cell is shown in a modulator OFF state, with a minimum amount of the droplet and thus the contained lumiphor exposed to light passing through the modulator. The droplet to the right in the drawing is shown in a modulator ON state, with a larger amount of the droplet and thus the contained lumiphor exposed to light passing through the modulator. The OFF state produces a low degree of wavelength shift, whereas the ON state produces a high degree of wavelength shift.

FIG. 8 depicts an optical modulator for light tubes. For purposes of illustration, FIG. 8 shows a tubular type skylight extending from an opening in the roof of a building through a ceiling over an interior space of the building. The exposed outer end of the tubular skylight has an entrance aperture for receiving daylight from outside the building and an exit aperture at the interior end of the skylight for supplying light to the interior of the building. The example of FIG. 8 uses a mechanical shutter that is fully inside the light tube and rotates vertically to switch the light tube between closed and opened states by blocking or allowing light to pass through the light tube. This drawing depicts a monolithic disk that would substantially cover most of the area of the tube when it is in the shut (OFF) position. The shutter could then be rotated to the open (ON) position that would allow an appropriate amount of light to be injected into the illuminated space via the light tube. For ease of illustration, the drawing shows the shutter as one big shutter, but it could be implemented instead using a number of small shutters which, together, end up blocking most of the light entering the tube.

Changeable reflectivity materials may change the quantity of light reflected (e.g. electrochromic coatings) or the distribution of how the light is reflected (i.e. switch between specular and diffuse reflection).

FIG. 9 depicts an alternate modulator for light tubes. The tube is shown extending from a roof to a ceiling in a manner similar to the preceding example.

In this case, we have a disk that extends outside of the light tube which can rotate on an axis that is roughly in line with the wall of the tube. The disk would have sections that are opaque (block light) and other sections that are relatively clear (allow light to pass).

Rotation of the disk periodically blocks and passes light, i.e. in a repeating cycle. Then, by rotating the disk at an appropriate speed, the light out of the tube can be modulated. The speed of rotation of the disk creates a pulsing light output of the daylighting device. Varying the frequency of rotation varies the frequency of the light pulses and may be used to carry relevant data.

Here, the disk may have sections cut out that when spun at a defined speed transmit light whereas other sections of the disk block light. A combination of cutouts may provide a desired pattern of transmission/blockage of the light. The alternately opaque and transmissive disk could also be a solid optical piece that has segments of switchable glass. This approach could mitigate issues of slow switching of switchable glass. Segments can be selectively made transparent or blocking to provide appropriate patterns for a desired light output signal.

Hence, a unique pattern of modulated light can be achieved either by selecting the relative size of blocking and transmissive areas and rotating at a relatively constant speed, or by having regularly spaced blocking and transmissive areas and altering the rotational speed. Alternately, different areas could be made on a transparent disk with different phosphors (or QDs) so that the output light shifts between two or more spectra as the different areas of the disk are rotated into the tube.

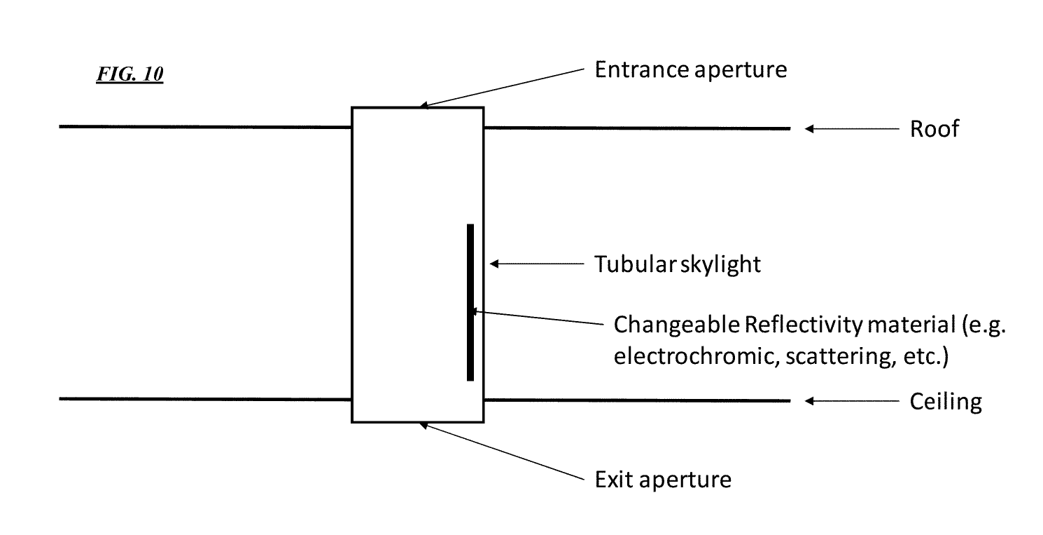

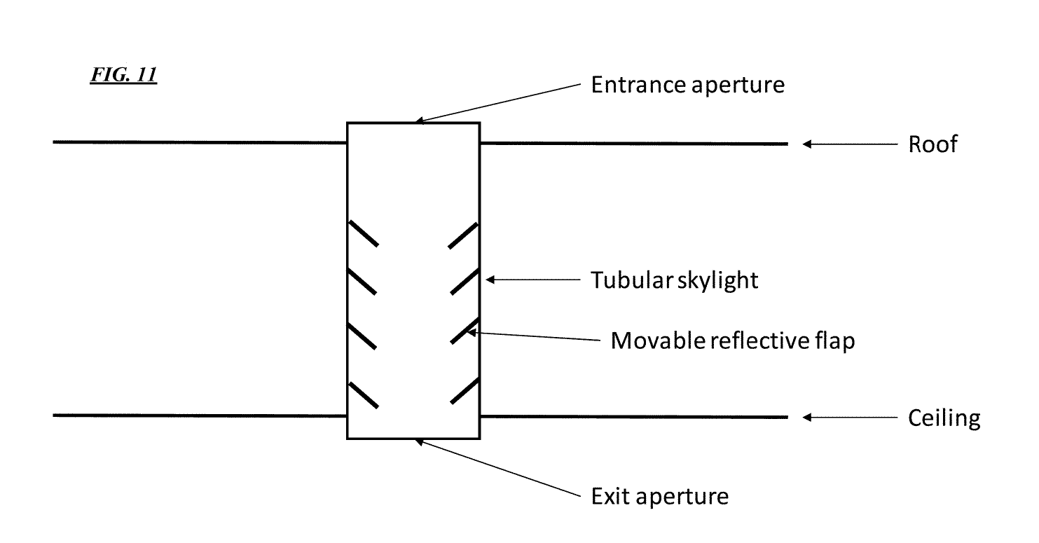

FIG. 10 illustrates a further alternate modulator for light tubes, again in a similar arrangement relative to a roof and a ceiling. In this example, the total light output of the tube is changed by changing the relative reflectivity of the wall of the tube (or portion thereof). Changeable reflectivity materials may change the quantity of light reflected (e.g. electrochromic coatings) or the distribution of how the light is reflected (i.e. switch between specular and diffuse reflection) and quantity or distribution of light output from the light tube.

As an example, an electrochromic coating may be used (like those used on car rearview mirrors). Alternately, a coating or layer that can be changed from scattering to specular reflection also can be used since in the scattering state, some portion of the incident light would be reflected back towards the entrance aperture and therefore would not reach the room. Examples of these types of materials include liquid crystal-based privacy glass. Switching the reflectivity of such a material changes the efficiency of the light tube and thus modulates the quantity/intensity of light carried through into the interior space below the ceiling.

FIG. 11 illustrates a further alternate modulator for light tubes, conceptually similar to the example of FIG. 10. In this example, the shape of the tube walls are mechanically moved to change the net transmissivity of the overall tube (e.g. the surface properties of the reflective material would not be changed). In the example shown, hinged flaps could be cut into the wall or installed inside that can be oriented (with a motor, piezoelectric device(s), etc.) to either maximize the light transport ability of the tube or to reflect some portion of the light substantially back towards the entrance aperture and thus reducing the quantity/intensity of light output. As in the preceding example, this switching of tube wall reflectivity changes the efficiency of the light tube and thus modulates the quantity/intensity of light carried through into the interior space below the ceiling.

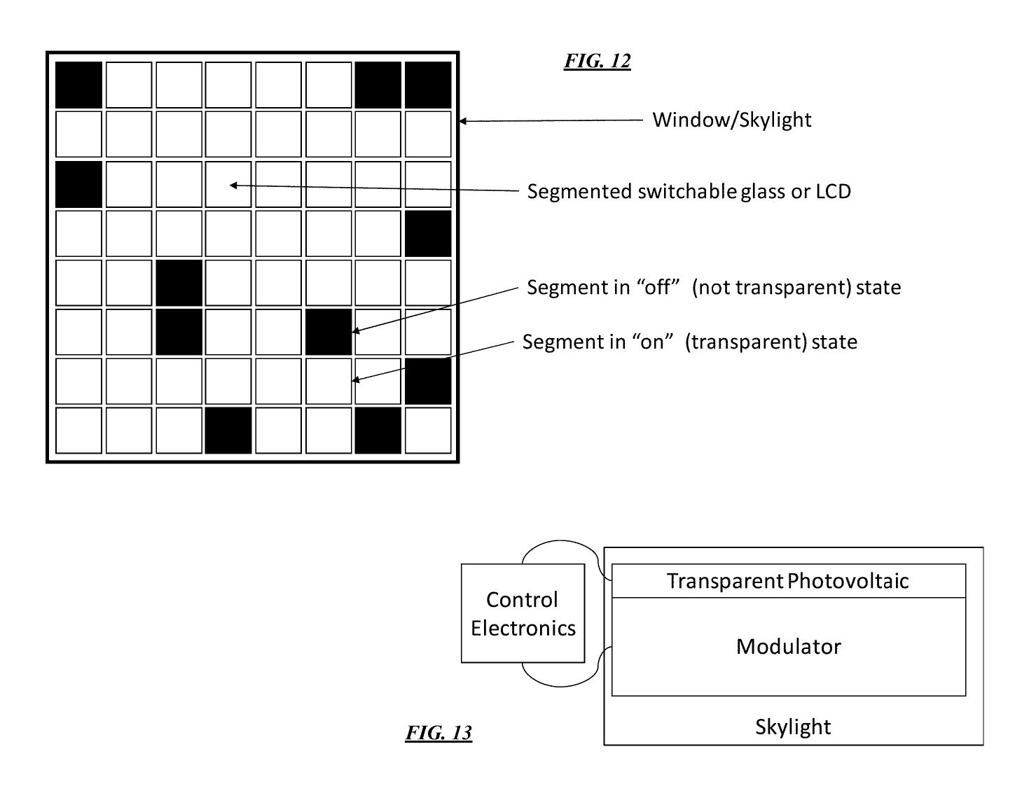

FIG. 12 shows a segmented modulator, e.g. using an array of switchable optical elements to provide a selected spatial pattern. The modulator, for example, might extend across the path of light through a light tube or other daylighting device. The example represents a square array, but the array could be constructed in any shape suitable for implementation in or combined with a particular type of daylighting device. The array could be implemented, for example, using cells of switchable glass. The pattern may represent data if detectable by the intended sensor in the receiving device. For example, control of the pattern of ON/OFF cells across the modulator array could transmit data through watermarking or time-varying watermarking. Each segment could transmit some limited amount of information, therefore multiple segments could offer multiple channels. Also, further information can be transmitted by selecting the pattern of “active” segments (e.g. segments that are switching). Alternately, some fixed number of segments could be kept in the “off” state, but by changing the pattern of “off” and “on” segments, transmit information. The figure shows the segments as a square array, but any tiling could work. The segments could also be restricted to limited areas of the window/skylight (e.g. just near the borders to avoid ruining the view). Alternatively, the pattern may vary over time to change the amount of light passing through the daylighting device, in a manner similar to several of the earlier examples.

The modulators and modulation techniques discussed above and shown in the drawings are intended as non-limiting examples. The modulators and modulation techniques may be implemented in other ways or locations in or about passive optical element.

For example, either the optical input aperture or the optical output aperture of the passive optical element may have a border region within the area of optical input or output of the element; and a modulator may be located in or near that border region to modulate the daylight passing through that border region. Other light would pass through the passive lighting device without modulation. In a similar arrangement, an optical modulator may operate on a differently shaped or located portion of either the optical input aperture or the optical output aperture of the passive optical element, such as a central region (but not all of) the respective aperture, a bar extending partially or completely across the respective aperture, a cross or x-shaped region of the aperture, etc. Similar regionalized modulators also could be located at intermediate locations along the passive optical element, e.g. at about the middle of a light tube type skylight. The region of modulation in these additional examples need not approach the full area of the light passage or aperture of the passive optical element but might only encompass enough area to modulate light passing through the element that is sufficient to enable a device to detect the modulation from light received from the passive lighting device and recover the data or other information carried by the modulated light.

As another example, for applications requiring communication of minimal information, e.g. providing a parameter sufficient to uniquely identify a lighting device within a given premises, the modulators may be controlled in other simpler ways. For example, rather than modulating the light according to digital data or an identification code, using a processor or the like, the circuitry controlling the modulation may be set to uniquely encode a detectable parameter of the light modulation (e.g. frequency, duty cycle, modulation depth, etc.) over a long period of time without change. In one more specific example, a simple oscillator may have a frequency control setting of an R (resistance) and/or a C (capacitance) value of a resonant circuit or the like that establishes the oscillation frequency. Such an oscillator then might drive the optical modulator at a set frequency that can be detected by the expected receiver. By setting the frequency values for different passive lighting devices about the premises to modulate the light at detectably different frequencies, each passive lighting device can be identified based on detection of its respective modulation frequency. With this approach, the frequencies can be set at installation and commissioning and can remain as initially set for an indefinite period (e.g. until there is some need for change).

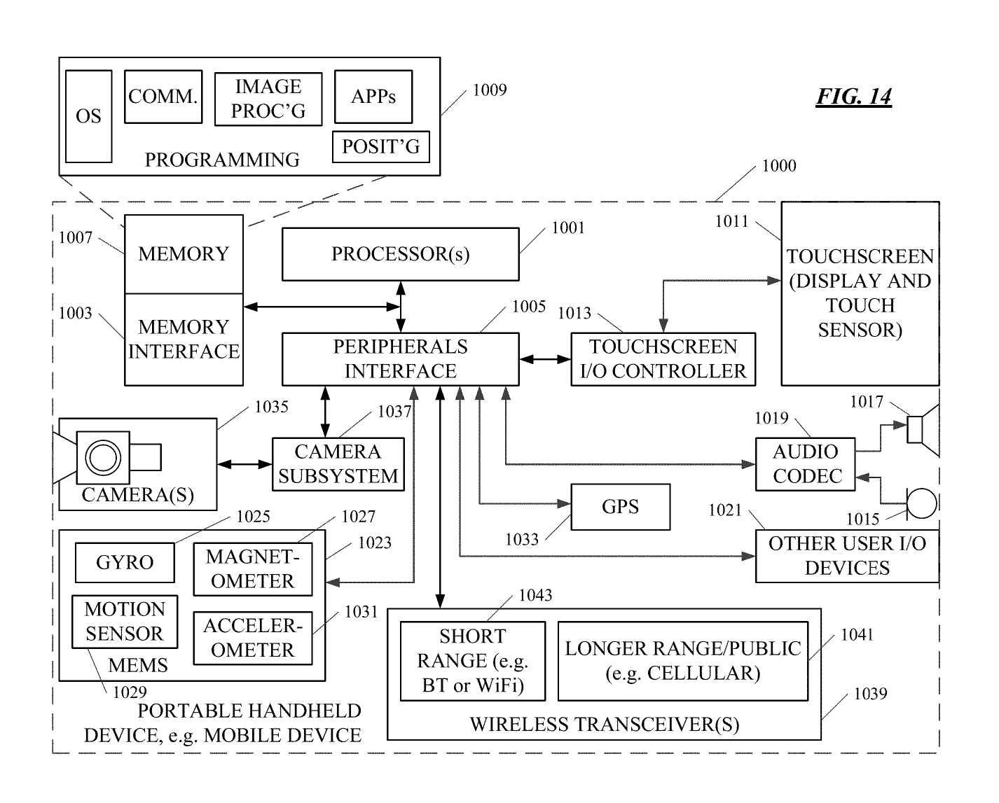

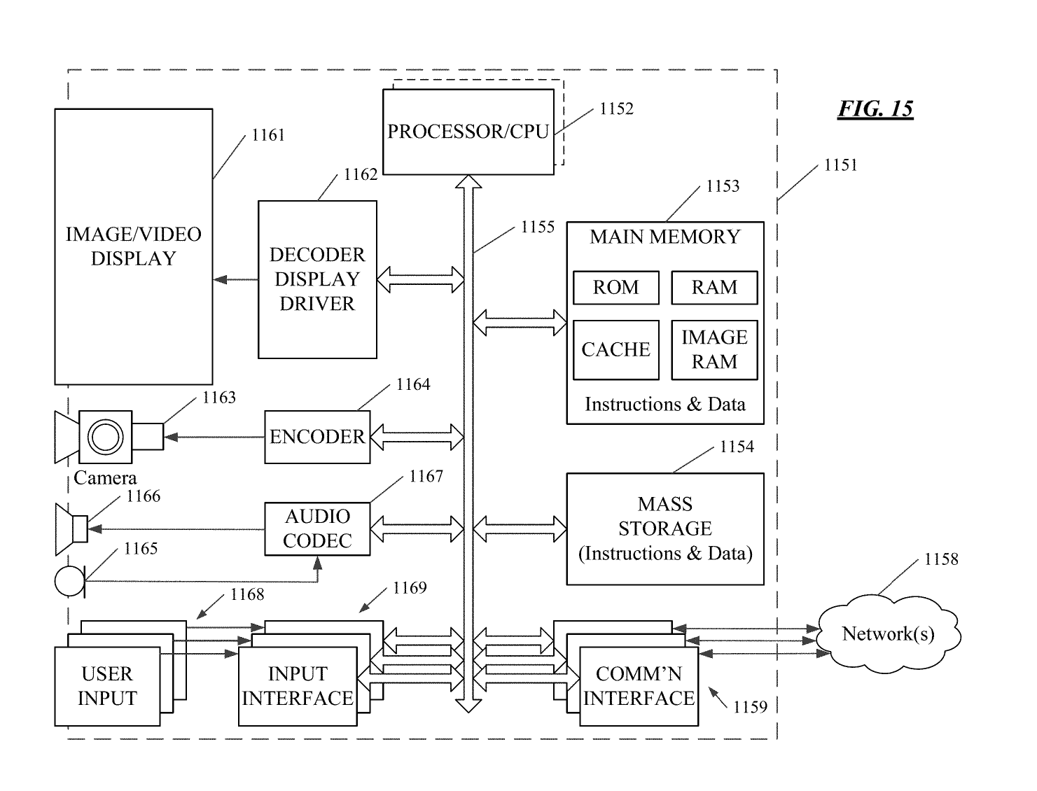

FIG. 13 is a simplified block diagram illustrating a technique to obtain power, e.g. for the optical modulator(s), through energy harvesting in or around a daylighting device. A transducer can pick up and convert to electricity one or more of any type of ambient energy (e.g. photovoltaics, wind, vibration, acoustic, etc.). The example, shows a transparent photovoltaic in a skylight. Some light passes through the photovoltaic to the modulator and the rest of the skylight, in a manner similar to earlier examples. The photovoltaic, however, converts some light to electricity, which is supplied to the control electronics and used to drive the modulator. Energy harvesting may be integrated into the structure of the modulator/electronics/passive lighting device. The transducer for energy harvesting may be external (e.g. roof mounted next to skylight aperture).

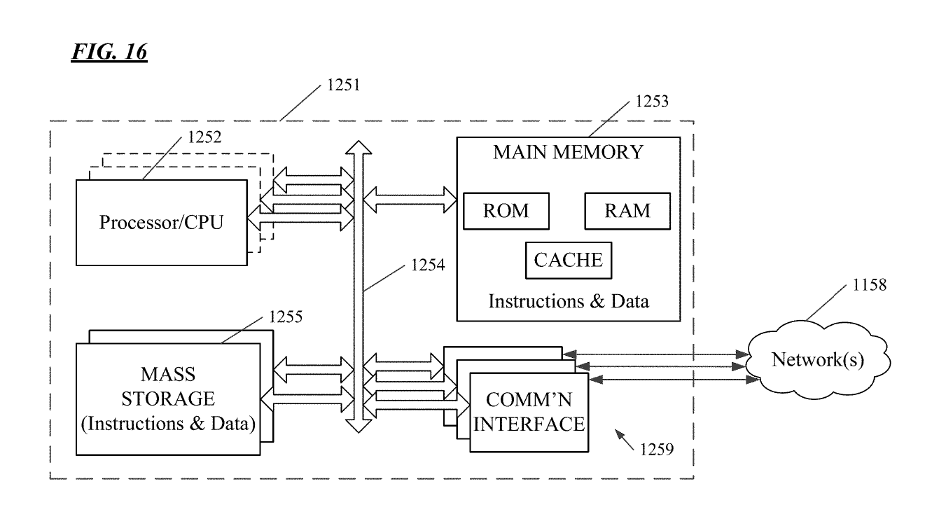

As shown by the above discussion, at least some functions using the modulated light transmissions from one or more passive lighting devices may be implemented on a portable handheld device, shown by way of a mobile device 25 in FIG. 2. At a high level, such a portable handheld device includes components such as a camera or other light sensor and a processor coupled to the camera or other light sensor to control operation thereof and to receive and image data or other type of light sensing signal from the camera or sensor. A memory is coupled to be accessible to the processor, and the memory contains programming for execution by the processor. The portable handheld device may be any of a variety of modern devices, such as a handheld digital music player, a portable video game or handheld video game controller, etc. In most examples discussed herein, the portable handheld device is a mobile device, such as a smartphone, a wearable smart device (e.g. watch or glasses), a tablet computer, a device that can be attached to a mobile object or the like. Those skilled in such hi-tech portable handheld devices will likely be familiar with the overall structure, programming and operation of the various types of such devices. For completeness, however, it may be helpful to summarize relevant aspects of a mobile device as just one example of a suitable portable handheld device. For that purpose, FIG. 14 provides a functional block diagram illustrations of a mobile device 1051, which may serve as the device 25 in the system of FIG. 2.

In the example, the mobile device 1000 includes one or more processors 1001, such as a microprocessor or the like serving as the central processing unit (CPU) or host processor of the device 1000. Other examples of processors that may be included in such a device include math co-processors, image processors, application processors (APs) and one or more baseband processors (BPs). The various included processors may be implemented as separate circuit components or can be integrated in one or more integrated circuits, e.g. on one or more chips. For ease of further discussion, we will refer to a single processor 1001, although as outlined, such a processor or processor system of the device 1000 may include circuitry of multiple processing devices.

In the example, the mobile device 1000 also includes memory interface 1003 and peripherals interface 1005, connected to the processor 1001 for internal access and/or data exchange within the device 1000. These interfaces 1003, 1005 also are interconnected to each other for internal access and/or data exchange within the device 1000. Interconnections can use any convenient data communication technology, e.g. signal lines or one or more data and/or control buses (not separately shown) of suitable types.

In the example, the memory interface 1003 provides the processor 1001 and peripherals coupled to the peripherals interface 1003 storage and/or retrieval access to memory 1007. Although shown as a single hardware circuit for convenience, the memory 1007 may include one, two or more types of memory devices, such as high-speed random access memory (RAM) and/or non-volatile memory, such as read only memory (ROM), flash memory, micro magnetic disk storage devices, etc. As discussed more later, memory 1007 stores programming 1009 for execution by the processor 1001 as well as data to be saved and/or data to be processed by the processor 1001 during execution of instructions included in the programming 1007. New programming can be saved to the memory 1005 by the processor 1001. Data can be retrieved from the memory 1005 by the processor 1001; and data can be saved to the memory 1007 and in some cases retrieved from the memory 1007, by peripherals coupled via the interface 1005.

In the illustrated example of a mobile device architecture, sensors, various input output devices, and the like are coupled to and therefore controllable by the processor 1001 via the peripherals interface 1005. Individual peripheral devices may connect directly to the interface or connect via an appropriate type of subsystem.

The mobile device 1000 also includes appropriate input/output devices and interface elements. The example offers visual and audible inputs and outputs, as well as other types of inputs. Some or all of the user input/output devices may be used in conjunction with features or applications that also utilize data that the device receives via light communication from a modulated passive lighting device and/or from a modulated luminaire, for example, to present a device position estimation based on such received data or to present selected content or other user data transported via the modulated light.

Although a display together with a keyboard/keypad and/or mouse/touchpad or the like may be used, the illustrated mobile device example 1000 uses a touchscreen 1013 to provide a combined display output to the device user and a tactile user input. The display may be a flat panel display, such as a liquid crystal display (LCD). For touch sensing, the user inputs would include a touch/position sensor, for example, in the form of transparent capacitive electrodes in or overlaid on an appropriate layer of the display panel. At a high level, a touchscreen displays information to a user and can detect occurrence and location of a touch on the area of the display. The touch may be an actual touch of the display device with a finger, stylus or other object; although at least some touchscreens can also sense when the object is in close proximity to the screen. Use of a touchscreen 1011 as part of the user interface of the mobile device 1000 enables a user of that device 1000 to interact directly with the information presented on the display.

A touchscreen input/output (I/O) controller 1013 is coupled between the peripherals interface 1005 and the touchscreen 1011. The touchscreen I/O controller 1013 processes data received via the peripherals interface 1005 and produces drive signals for the display component of the touchscreen 1011 to cause that display to output visual information, such as images, animations and/or video. The touchscreen I/O controller 1013 also includes the circuitry to drive the touch sensing elements of the touchscreen 1011 and processing the touch sensing signals from those elements of the touchscreen 1011. For example, the circuitry of touchscreen I/O controller 1013 may apply appropriate voltage across capacitive sensing electrodes and process sensing signals from those electrodes to detect occurrence and position of each touch of the touchscreen 1011. The touchscreen I/O controller 1013 provides touch position information to the processor 1001 via the peripherals interface 1005, and the processor 1001 can correlate that information to the information currently displayed via the display 1161, to determine the nature of user input via the touchscreen.

As noted, the mobile device 1000 in our example also offers audio inputs and/or outputs. The audio elements of the device 1000 support audible communication functions for the user as well as providing additional user input/output functions. Hence, in the illustrated example, the mobile device 1000 also includes a microphone 1015, configured to detect audio input activity, as well as an audio output component such as one or more speakers 1017 configured to provide audible information output to the user. Although other interfaces subsystems may be used, the example utilizes an audio coder/decoder (CODEC), as shown at 1019, to interface audio to/from the digital media of the peripherals interface 1005. The CODEC 1019 converts an audio responsive analog signal from the microphone 1015 to a digital format and supplies the digital audio to other element(s) of the system 1151, via the peripherals interface 1005. The CODEC 1019 also receives digitized audio via the peripherals interface 1005 and converts the digitized audio to an analog signal which the CODEC 1019 outputs to drive the speaker 1017. Although not shown, one or more amplifiers may be included in the audio system with the CODEC to amplify the analog signal from the microphone 1015 or the analog signal from the CODEC 1019 that drives the speaker 1017.

Other user input/output (I/O) devices 1021 can be coupled to the peripherals interface 1005 directly or via an appropriate additional subsystem (not shown). Such other user input/output (I/O) devices 1021 may include one or more buttons, rocker switches, thumb-wheel, infrared port, etc. as additional input elements. Examples of one or more buttons that may be present in a mobile device 1000 include a home or escape button, an ON/OFF button, and an up/down button for volume control of the microphone 1015 and/or speaker 1017. Examples of output elements include various light emitters or tactile feedback emitters (e.g. vibrational devices). If provided, functionality of any one or more of the buttons, light emitters or tactile feedback generators may be context sensitive and/or customizable by the user. For example, in a mapping and navigation application using position estimates based on reception of modulated light, the device 1000 might emit a ping sound or the like via the speaker 1017 and/or operate a tactile feedback emitter to vibrate the device 1000, as an indication when a walking user deviates from a recommended navigation route.

The mobile device 1000 in the example also includes one or more Micro Electro-Magnetic System (MEMS) sensors shown collectively at 1023. Such devices 1023, for example, can perform compass and orientation detection functions and/or provide motion detection. In this example, the elements of the MEMS 1023 coupled to the peripherals interface 1005 directly or via an appropriate additional subsystem (not shown) include a gyroscope (GYRO) 1025 and a magnetometer 1027. The elements of the MEMS 1023 may also include a motion detector 1029 and/or an accelerometer 1031, e.g. instead of or as a supplement to detection functions of the GYRO 1025. Signals from such sensors may be used in combination with data obtained from received modulated light, e.g. to enhance position estimations and/or navigation functions.

The mobile device 1000 in the example also includes a global positioning system (GPS) receiver 1033 coupled to the peripherals interface 1005 directly or via an appropriate additional subsystem (not shown). In general, a GPS receiver 1033 receives and processes signals from GPS satellites to obtain data about the positions of satellites in the GPS constellation as well timing measurements for signals received from several (e.g. 3-5) of the satellites, which a processor (e.g. the host processor 1001 or another internal or remote processor in communication therewith) can process to determine the geographic location of the device 1000. Position information obtained from GPS also may be used in combination with data obtained from received modulated light, e.g. to detect entry to premises 15 and trigger a wireless download of data regarding the premises that the device 1000 then accesses based on data obtained from received modulated light.

The portable handheld device 1000, as may be used as device 25 when operating in system 10 of FIG. 2, includes at least one image sensor to capture an image of some portion or all of a passive lighting device and/or of a modulated luminaire. The signal generated by the light sensor comprises data representing the captured image and is responsive to received modulated light. It should be understood, however, that the portable handheld device 1000 may include other types of light sensors instead of or in addition to the image sensor(s). For purposes of discussion, we will consider a camera implementation of the light/image sensor.

Hence, in the example of FIG. 14, the mobile device 1000 further includes one or more cameras 1035 as well as camera subsystem 1037 coupled to the peripherals interface 1005. A smartphone or tablet type mobile station often includes a front facing camera and a rear or back facing camera. Some recent designs of mobile stations, however, have featured additional cameras. Although the camera 1035 may use other image sensing technologies, current examples often use a charged coupled device (CCD) or a complementary metal-oxide semiconductor (CMOS) optical sensor. At least some of such cameras implement a rolling shutter image capture technique, whereas other cameras implement a global shutter image capture technique. The camera subsystem 1037 controls the camera operations in response to instructions from the processor 1001; and the camera subsystem 1037 may provide digital signal formatting of images captured by the camera 1035 for communication data or other types of signal(s) representing each image via the peripherals interface 1005 to the processor or other elements of the device 1000.

The processor 1001 controls each camera 1035 via the peripherals interface 1005 and the camera subsystem 1037 to perform various image or video capture functions, for example, to take pictures or video clips in response to user inputs. The processor 1001 may also control a camera 1035 via the peripherals interface 1005 and the camera subsystem 1037 to obtain data detectable in a captured image, such as data represented by a code in an image or in visible light communication (VLC) detectable in an image. In the data capture case, the camera 1035 and the camera subsystem 1037 supply image data via the peripherals interface 1005 to the processor 1001, and the processor 1001 processes the image data to extract or demodulate data from the captured image(s). Alternatively, the camera subsystem 1037 may implement sufficient processing capability to, when instructed, perform some or all of VLC data demodulation function and simply provide demodulated data to the host processor 1001.

Voice and/or data communication functions are supported by one or more wireless communication transceivers 1039. In the example, the mobile device includes a cellular or other mobile transceiver 1041 for longer range communications via a public mobile wireless communication network. A typical modern device, for example, might include a 4G LTE (long term evolution) type transceiver. Although not shown for convenience, the mobile device 1001 may include additional digital or analog transceivers for alternative wireless communications via a wide area wireless mobile communication network.

Many modern mobile devices also support wireless local communications over one or more standardized wireless protocols. Hence, in the example, the wireless communication transceivers 1039 also include at least one shorter range wireless transceiver 1043. Typical examples of the wireless transceiver 1043 include various iterations of WiFi (IEEE 802.11) transceivers and Bluetooth (IEEE 802.15) transceivers, although other or additional types of shorter range transmitters and/or receivers may be included for local communication functions.

The data communication functions offered by transceiver 1039 or the transceiver 1043 may be used in conjunction with VLC data received from a modulated passive lighting device 2 and/or from a luminaire 11v, e.g. to provide map or other location related information corresponding to a VLC identified device 2 or luminaire 11v or corresponding to a position estimated based on VLC data from a device 2 or a luminaire 11v.

As noted earlier, the memory 1007 stores programming 1009 for execution by the processor 1001 as well as data to be saved and/or data to be processed by the processor 1001 during execution of instructions included in the programming 1007. For example, the programming 1007 may include an operating system (OS) and programming for typical functions such as communications (COMM.), image processing (IMAGE PROC′G) and positioning (POSIT′G). Examples of typical operating systems include iOS, Android, BlackBerry OS and Windows for Mobile. The OS also allows the processor 1007 to execute various higher layer applications (APPs) that use the native operation functions such as communications, image processing and positioning. For example, receiving data from a modulated passive lighting device 2 and/or from a luminaire 11v may use the image processing function, and the positioning function may be configured to determine an estimated position of the device 1000 from either one or both of GPS or VLC (and/or other supported technologies such as Bluetooth). One or more of the higher layer applications will configure the device to utilize the data demodulated from received VLC, for example, to present a representation of the estimated device position, information obtain from communication with a server or the like that corresponds to the estimated position or to present content received via VLC from a modulated passive lighting device 2 and/or from a luminaire 11v.

A personal computer such as shown at 27 in FIG. 2 may communicate with a mobile device 25, including via VLC through a modulated passive lighting device 2 and/or from a luminaire 11v. Alternatively, a personal computer is another example of a user device that may receive VLC transmission, e.g. as a portable alternative to the mobile device 25. In any case, from the user's perspective, such mobile or portable user computer devices are often implemented to run “client” programming to obtain and/or ‘consume’ services from a general class of data processing device commonly used to run “server” programming. The server computer may be configured to implement the functions of computer 29 and/or store the database 31 that provide the VLC services discussed above. Those skilled in such hi-tech computer devices will likely be familiar with the overall structure, programming and operation of the various types of user/client devices and server computer devices. For completeness, however, it may be helpful to summarize relevant aspects of such computer devices by way of examples of devices 27, 29.

At a high level, a general-purpose computing device, computer or computer system typically comprises a central processor or other processing device, internal data connection(s), various types of memory or storage media (RAM, ROM, EEPROM, cache memory, disk drives etc.) for code and data storage, and one or more network interfaces for communication purposes. The software functionalities involve programming, including executable code as well as associated stored data, e.g. files used for the VLC service/function(s). The software code is executable by the central processing unit of the general-purpose computer that functions as the server 29 and/or that functions as a user terminal device 27. In operation, the code is stored within the general-purpose computer platform. At other times, however, the software may be stored at other locations and/or transported for loading into the appropriate general-purpose computer system. Execution of such code by a processor of the computer platform enables the platform to implement the respective functions relating to or utilizing VLC via a modulated passive lighting device 2 and/or from a luminaire 11v, in essentially the manner performed in the implementations discussed and illustrated herein.

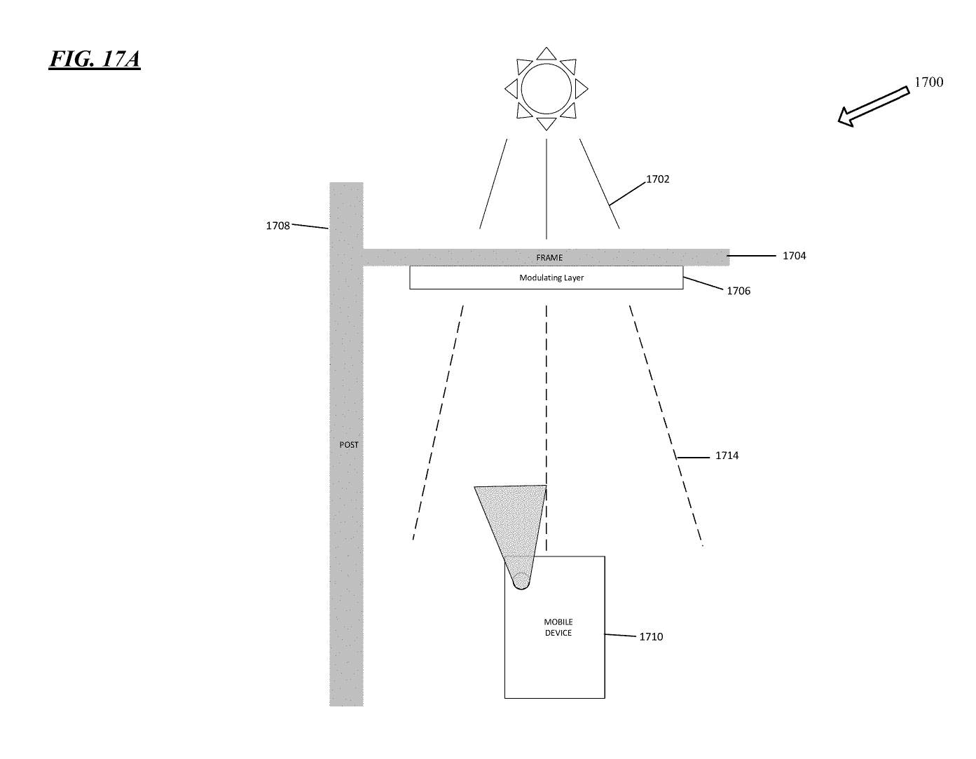

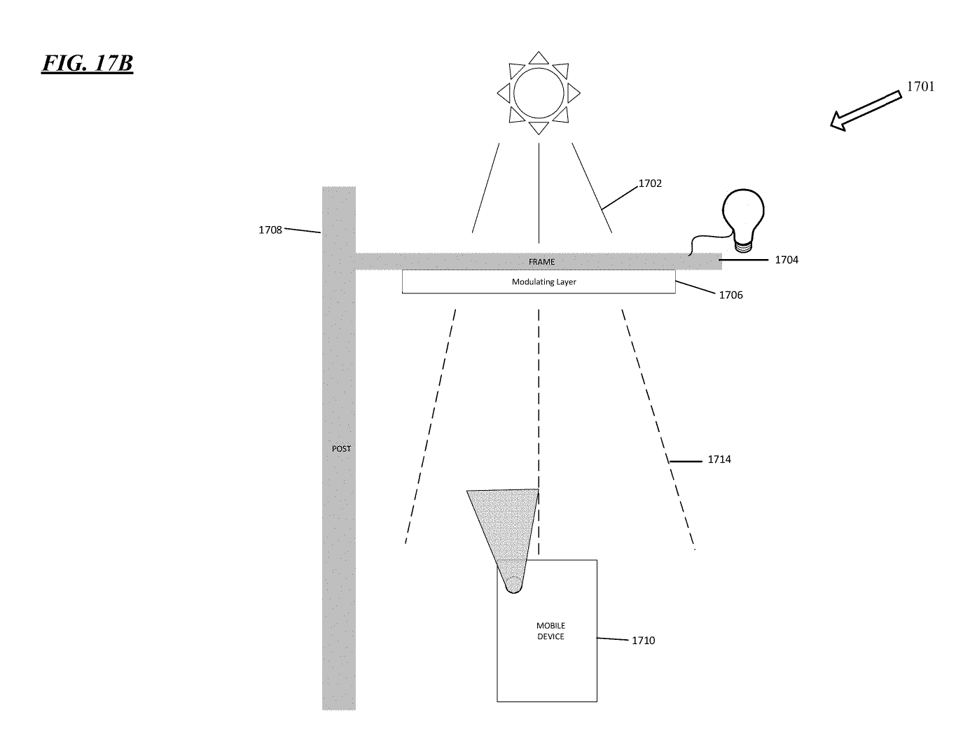

FIGS. 15 and 16 provide functional block diagram illustrations of general purpose computer hardware platforms. FIG. 15 depicts a computer with user interface elements, as may be used to implement a client computer or other type of work station or terminal device, although the computer of FIG. 15 may also act as a host or server if appropriately programmed. FIG. 16 illustrates a network or host computer platform, as may typically be used to implement a server.

With reference to FIG. 15, a user device type computer system 1151, which may serve as the terminal 27, includes processor circuitry forming a central processing unit (CPU) 1152. The circuitry implementing the CPU 1152 may be based on any processor or microprocessor architecture such as a Reduced instruction set computing (RISC) using an ARM architecture, as commonly used today in mobile devices and other portable electronic devices, or a microprocessor architecture more commonly used in computers such as an instruction set architecture (ISA) or Complex instruction set computing (CISC) architecture. The CPU 1152 may use any other suitable architecture. Any such architecture may use one or more processing cores. The CPU 1152 may contain a single processor/microprocessor, or it may contain a number of microprocessors for configuring the computer system 1152 as a multi-processor system.

The computer system 1151 also includes a main memory 1153 that stores at least portions of instructions for execution by and data for processing by the CPU 1152. The main memory 1153 may include one or more of several different types of storage devices, such as read only memory (ROM), random access memory (RAM), cache and possibly an image memory (e.g. to enhance image/video processing). Although not separately shown, the memory 1153 may include or be formed of other types of known memory/storage devices, such as PROM (programmable read only memory), EPROM (erasable programmable read only memory), FLASH-EPROM, or the like.

The system 1151 also includes one or more mass storage devices 1154. Although a storage device 1154 could be implemented using any of the known types of disk drive or even tape drive, the trend is to utilize semiconductor memory technologies, particularly for portable or handheld system form factors. As noted, the main memory 1153 stores at least portions of instructions for execution and data for processing by the CPU 1152. The mass storage device 1154 provides longer term non-volatile storage for larger volumes of program instructions and data. For a personal computer, or other similar device example, the mass storage device 1154 may store the operating system and application software as well as content data, e.g. for uploading to main memory and execution or processing by the CPU 1152. Examples of content data include messages and documents, and various multimedia content files (e.g. images, audio, video, text and combinations thereof). Instructions and data can also be moved from the CPU 1152 and/or memory 1153 for storage in device 1154.

The processor/CPU 1152 is coupled to have access to the various instructions and data contained in the main memory 1153 and mass storage device 1154. Although other interconnection arrangements may be used, the example utilizes an interconnect bus 1155. The interconnect bus 1155 also provides internal communications with other elements of the computer system 1151.

The system 1151 also includes one or more input/output interfaces for communications, shown by way of example as several interfaces 1159 for data communications via a network 1158. The network 1158 may be or communicate with the network 17 or 23 of system 10 in FIG. 2. Although narrowband modems are also available, increasingly each communication interface 1159 provides a broadband data communication capability over wired, fiber or wireless link. Examples include wireless (e.g. WiFi) and cable connection Ethernet cards (wired or fiber optic), mobile broadband ‘aircards,’ and Bluetooth access devices. Infrared and visual light type wireless communications are also contemplated. Outside the system 1151, the interface provides communications over corresponding types of links to the network 1158. In the example, within the system 1151, the interfaces communicate data to and from other elements of the system via the interconnect bus 1155.

For operation as a user terminal device, the computer system 1151 further includes appropriate input/output devices and interface elements. The example offers visual and audible inputs and outputs, as well as other types of inputs. Although not shown, the system may also support other types of output, e.g. via a printer. The input and output hardware devices are shown as elements of the device or system 1151, for example, as may be the case if the computer system 1151 is implemented as a portable computer device (e.g. laptop, notebook or ultrabook), tablet computer, smartphone or other handheld device. In other implementations, however, some or all of the input and output hardware devices may be separate devices connected to the other system elements via wired or wireless links and appropriate interface hardware.

For visual output, the computer system 1151 includes an image or video display 1161 and an associated decoder and display driver circuit 1162. The display 1161 may be a projector or the like but typically is a flat panel display, such as a liquid crystal display (LCD). The decoder function decodes video or other image content from a standard format, and the driver supplies signals to drive the display 1161 to output the visual information. The CPU 1152 controls image presentation on the display 1161 via the display driver 1162, to present visible outputs from the device 1151 to a user, such as application displays and displays of various content items (e.g. still images, videos, messages, documents, and the like).

In the example, the computer system 1151 also includes a camera 1163 as a visible light image sensor. Various types of cameras may be used. The camera 1163 typically can provide still images and/or a video stream, in the example to an encoder 1164. The encoder 1164 interfaces the camera to the interconnect bus 1155. For example, the encoder 164 converts the image/video signal from the camera 1163 to a standard digital format suitable for storage and/or other processing and supplies that digital image/video content to other element(s) of the system 1151, via the bus 1155. Connections to allow the CPU 1152 to control operations of the camera 1163 are omitted for simplicity.

In the example, the computer system 1151 includes a microphone 1165, configured to detect audio input activity, as well as an audio output component such as one or more speakers 1166 configured to provide audible information output to the user. Although other interfaces may be used, the example utilizes an audio coder/decoder (CODEC), as shown at 1167, to interface audio to/from the digital media of the interconnect bus 1155. The CODEC 1167 converts an audio responsive analog signal from the microphone 1165 to a digital format and supplies the digital audio to other element(s) of the system 1151, via the bus 1155. The CODEC 1167 also receives digitized audio via the bus 1155 and converts the digitized audio to an analog signal which the CODEC 1167 outputs to drive the speaker 1166. Although not shown, one or more amplifiers may be included to amplify the analog signal from the microphone 1165 or the analog signal from the CODEC 1167 that drives the speaker 1166.

Depending on the form factor and intended type of usage/applications for the computer system 1151, the system 1151 will include one or more of various types of additional user input elements, shown collectively at 1168. Each such element 1168 will have an associated interface 1169 to provide responsive data to other system elements via bus 1155. Examples of suitable user inputs 1168 include a keyboard or keypad, a cursor control (e.g. a mouse, touchpad, trackball, cursor direction keys etc.).

Another user interface option provides a touchscreen display feature, which may be similar to the touchscreen 1011 discussed earlier. At a high level, use of a touchscreen display as part of the user interface enables a user to interact directly with the information presented on the display. The display may be essentially the same as discussed above relative to element 1161 as shown in the drawing. For touch sensing, however, the user inputs 1168 and interfaces 1169 would include a touch/position sensor and associated sense signal processing circuit. The touch/position sensor is relatively transparent, so that the user may view the information presented on the display 1161. The sense signal processing circuit receives sensing signals from elements of the touch/position sensor and detects occurrence and position of each touch of the screen formed by the display and sensor. The sense circuit provides touch position information to the CPU 1152 via the bus 1155, and the CPU 1152 can correlate that information to the information currently displayed via the display 1161, to determine the nature of user input via the touchscreen.

The computer system 1151 runs a variety of applications programs and stores data, enabling one or more interactions via the user interface, provided through elements, and/or over the network 1158 to implement the desired user device processing. For example, programming of the system 1151 may enable a technician to operate the device 1151 to instruct a system 1 (FIG. 1) to transmit an assigned identifier (ID) over modulated light and configure an entry in the database 31 for the particular system 1, e.g. to correlate information identifying a known location of the passive lighting device 2 to the assigned ID and/or location-related information corresponding to the location of the device 2. In other uses of the computer system 1151, the programming may configure that system 1151 to use VLC communication from a passive lighting device 2 and/or a luminaire 11v in a manner similar to the device 1000 discussed earlier.

Turning now to consider a server or host computer, FIG. 16 is a functional block diagram of a general-purpose computer system 1251, which may perform the functions of the server 29 for VLC services 28 (see FIG. 2). Such a computer may also store the database 31, although the database may reside on other hardware accessible to the processor of the server computer.

The example 1251 will generally be described as an implementation of a server computer, e.g. as might be configured as a blade device in a server farm. Alternatively, the computer system may comprise a mainframe or other type of host computer system capable of web-based communications, media content distribution, or the like via the network 1158. Although shown as the same network as served the user computer system 1151, the computer system 1251 may connect to a different network.

The computer system 1251 in the example includes a central processing unit (CPU) 1252, a main memory 1253, mass storage 1255 and an interconnect bus 1254. These elements may be similar to elements of the computer system 1151 or may use higher capacity hardware. The circuitry forming the CPU 1252 may contain a single microprocessor, or may contain a number of microprocessors for configuring the computer system 1252 as a multi-processor system, or may use a higher speed processing architecture. The main memory 1253 in the example includes ROM, RAM and cache memory; although other memory devices may be added or substituted. Although semiconductor memory may be used in the mass storage devices 1255, magnetic type devices (tape or disk) and optical disk devices typically provide higher volume storage in host computer or server applications. In operation, the main memory 1253 stores at least portions of instructions and data for execution by the CPU 1252, although instructions and data are moved between memory and storage and CPU via the interconnect bus in a manner similar to transfers discussed above relative to the system 1151 of FIG. 15.

The system 1251 also includes one or more input/output interfaces for communications, shown by way of example as interfaces 1259 for data communications via the network 23. Each interface 1259 may be a high-speed modem, an Ethernet (optical, cable or wireless) card or any other appropriate data communications device. To provide user data for VLC through a device 2 and/or a luminaire 11v, or alternatively to provide location related information for or based on VLC type position estimations, to a large number of users' client devices 25 and/o4 17, the interface(s) 1259 preferably provide(s) a relatively high-speed link to the network 1158. The physical communication link(s) may be optical, wired, or wireless (e.g., via satellite or cellular network).

Although not shown, the system 1251 may further include appropriate input/output ports for interconnection with a local display and a keyboard or the like serving as a local user interface for configuration, programming or trouble-shooting purposes. Alternatively, the server operations personnel may interact with the system 1251 for control and programming of the system from remote terminal devices via the Internet or some other link via network 1158.

The computer system 1251 runs a variety of applications programs to implement the server functions for VLC services 28 and may store the database 31 for the VLC services 28. Those skilled in the art will recognize that the computer system 1251 may run other programs and/or host other services, such as web-based or e-mail based services. As such, the system 1251 need not sit idle while waiting for VLC services related functions.

The example (FIG. 16) shows a single instance of a computer system 1251. Of course, the server or host functions may be implemented in a distributed fashion on a number of similar platforms, to distribute the processing load. Additional networked systems (not shown) may be provided to distribute the processing and associated communications, e.g. for load balancing or failover.

The hardware elements, operating systems and programming languages of computer systems like 1151, 1251 generally are conventional in nature, and it is presumed that those skilled in the art are sufficiently familiar therewith to understand implementation of the present VLC related techniques attributed to the user terminal computer 27 and the server computer 29 using suitable configuration and/or programming of such computer system(s) particularly as outlined above relative to 1151 of FIG. 15 and 1251 of FIG. 16.

Hence, aspects of methods of sending information using VLC through a passive lighting device 2 and/or a luminaire 11v and/or receiving and acting on data sent through a passive lighting device 2 and/or a luminaire 11v outlined above may be embodied in programming, e.g. in the form of software, firmware, or microcode executable by a portable handheld device, a user computer system, a server computer or other programmable device. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into platform such as one of the controllers of FIGS. 3 and 4, a portable handheld device like that of FIG. 14 or one of the computer platforms of FIGS. 15 and 16. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to one or more of “non-transitory,” “tangible” or “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage hardware in any computer(s), portable user devices or the like, such as may be used to implement the server computer 29, the personal computer 27, the mobile device 25 or controllers 18, 11v, etc. shown in the drawings. Volatile storage media include dynamic memory, such as main memory of such a computer or other hardware platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and light-based data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying data and/or one or more sequences of one or more instructions to a processor for execution.

Program instructions may comprise a software or firmware implementation encoded in any desired language. Programming instructions, when embodied in a machine readable medium accessible to a processor of a computer system or device, render computer system or device into a special-purpose machine that is customized to perform the operations specified in the program.

The above discussion has focused mostly on visible light communication (VLC) for an indoor or interior space. However, VLC and modulation of light from a passive light source can also be used to support, for example, an estimation of location or position or data transmission, in an outdoor or partially enclosed area such as, for example, a partially enclosed pavilion or breezeway by modulation of otherwise natural light.

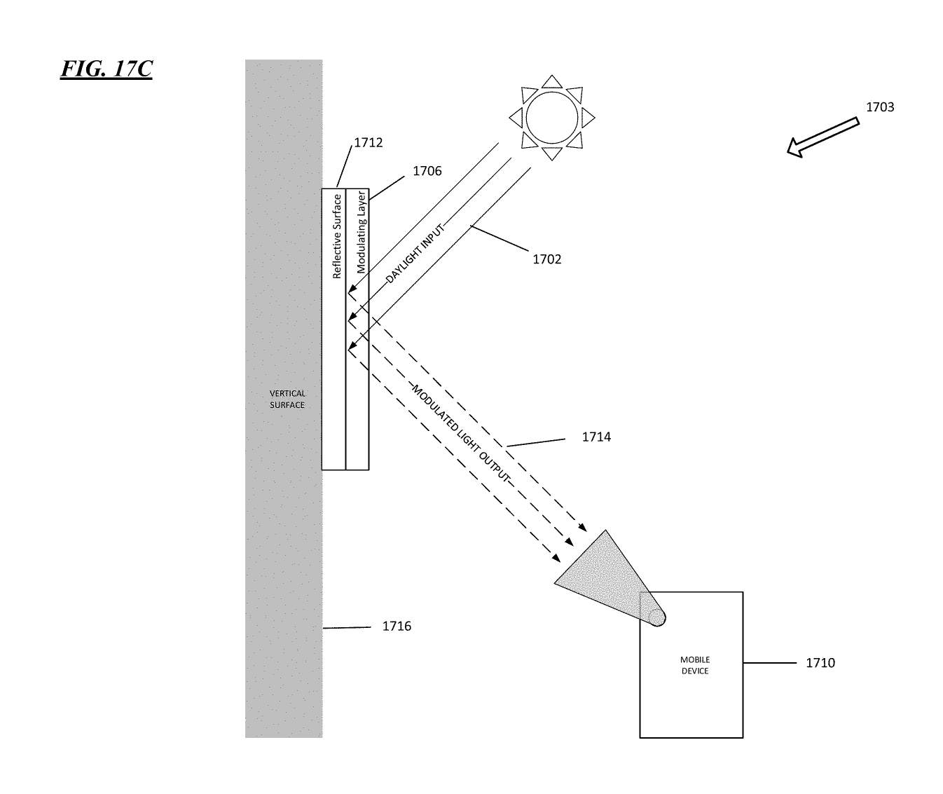

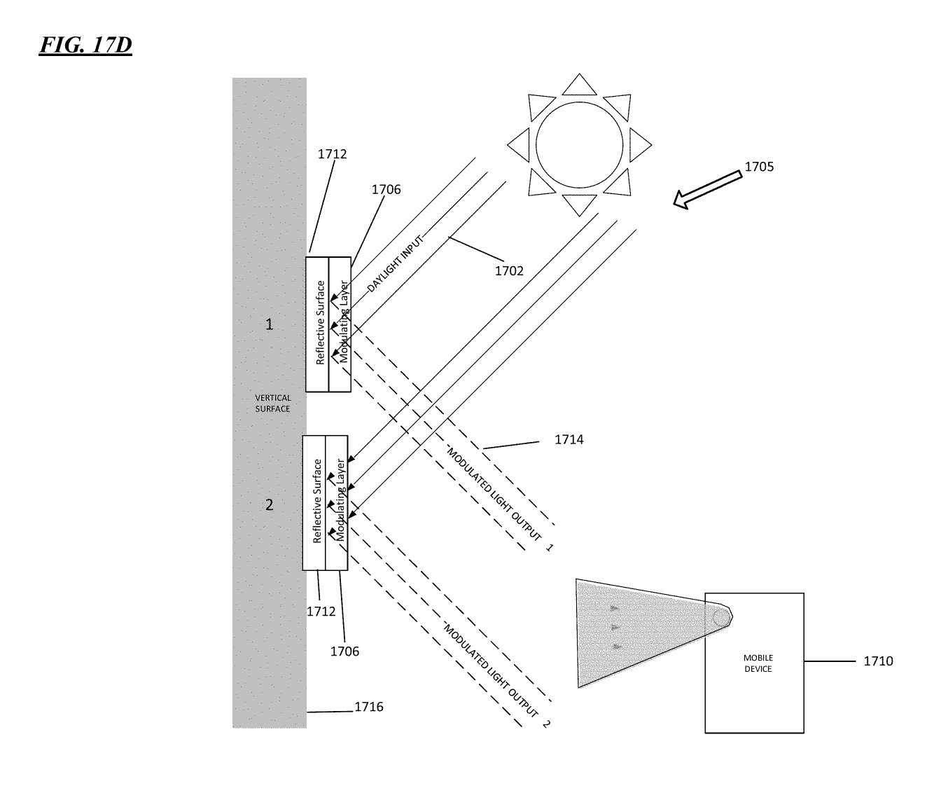

FIG. 17A illustrates a system 1700 for extending VLC to an outdoor or partially enclosed area in which a modulating layer is positioned overhead, and a mobile device has a direct view of a modulated signal or pattern, meaning the mobile device can observe the modulated signal or pattern as a direct source of light.

In system 1700, a modulating layer 1706 is framed in an overhead space 1704 that is supported by, for example, a post 1708. Rays of light 1702 from a passive light source, for example, sunlight or other natural light, pass through to the modulating layer 1706. The modulating layer 1706 modulates the passively supplied light to provide a modulated signal or pattern 1714. The modulated signal or pattern 1714 can be observed directly by a mobile device 1710 or any type of sensor or sensing device, for example, a stand-alone camera, a mobile handheld device having a camera or other light sensor, such as a smartphone, tablet computer or gaming device, or highly calibrated device configured to detect visible light. The frame 1704 for the modulating layer 1706 can be any passive optical element or structure such as transparent or translucent glass, an acrylic or plastic member in the form or part of a window, a skylight, partially enclosed pavilion, skywalk, seating area, or other device or structure that provides physical enclosure on at least one side of and structural support for the modulating layer 1706. As similarly discussed with respect to FIGS. 1 and 2 above, the passive optical element is at least substantially transmissive with respect to natural light. For example, the passive optical element is configured to receive the sunlight or natural light and allow passage of the light to the modulating layer 1706. The frame 1704 is configured to fixedly support and connect the modulating layer 1706 to the post 1708. In an alternate example, as illustrated in FIG. 17B, when there is insufficient natural light, the frame can be or include an artificial light source such as a luminaire in a street light mounted to the post 1708.

The modulating layer 1706 modulates light wavelengths in a range encompassing at least a substantial portion of the visible light spectrum. The modulating layer 1706 includes a material having a very high turn off/on speed faster than, for example, the materials of a liquid crystal display, for example, a holographic polymer dispersed liquid crystals (HPDLC), Pi-Cell, or Twisted Nematic.

The modulating layer 1706 may also be implemented to include a device such as a high speed piezo electric driver arranged to move multiple layers, for example, transparency layers each having a grating or pattern, to create a shuttering effect in which the light 1702 passes through to provide the modulated signal or pattern 1714. Examples of the high speed piezo electric driver include ultrasonic resonant motors, piezo linear motors, and co-fired piezo electric stacks or similar devices known in the art to perform such functions.

FIG. 17C illustrates a system 1703 for extending VLC to an outdoor area or partially enclosed area in which a modulated layer is arranged on a reflective surface and modulates data or natural light, and a mobile device has a direct view of a reflected modulated signal or pattern.

In system 1703, a modulating layer 1706 is mounted on a vertical surface 1716 having a reflective surface portion 1712 thereon, for example, aluminum, a highly reflective white paint or other colored paint within the visible spectrum having reflective properties, for example, colors such as red, green, or blue. A passive light source provides, for example, sunlight or other natural light, 1702 that passes through the modulating layer 1706 and is reflected by the reflective surface portion 1712 to provide a modulated signal or pattern 1714. The modulated signal or pattern 1714 can be observed directly by a mobile device 1710 or any type of sensor or sensing device, for example, an imaging device, a stand-alone camera, a mobile handheld device having a camera or other light sensor, such as a smartphone, tablet computer or gaming device, or highly calibrated device configured to detect visible light. The vertical surface 1716 for the modulating layer 1706 and the reflective surface 1712 can be any passive optical element structure such as transparent or translucent glass, an acrylic or plastic member in the form or part of a window, a skylight, partially enclosed pavilion, other device or structure that provides physical enclosure on at least one side of and structural support for the modulating layer 1706. In an alternative example, FIG. 17D illustrates a system 1705 for extending VLC to an outdoor area in which a plurality of modulators each having a modulating layer 1706. Each modulating layer 1706 is arranged on a reflecting surface 1712 and modulates data or natural light. A mobile device 1710 has a direct view of the reflected modulated signal or pattern 1714 from each modulated layer 1706. For convenience, FIG. 17D depicts two optical modulators each having a modulating layer 1706. One of ordinary skill in the art would recognize a “plurality of modulators” to be any number greater than one.

The vertical surface 1716 of FIGS. 17C and 17D is configured to fixedly support the modulating layer 1706 and the reflective surface 1712. Although shown and described as “vertical”, the surface 1716 may be somewhat angled, so long as the supported reflective surface 1712 can still adequately reflect/redirect the natural light to a desired space or area.

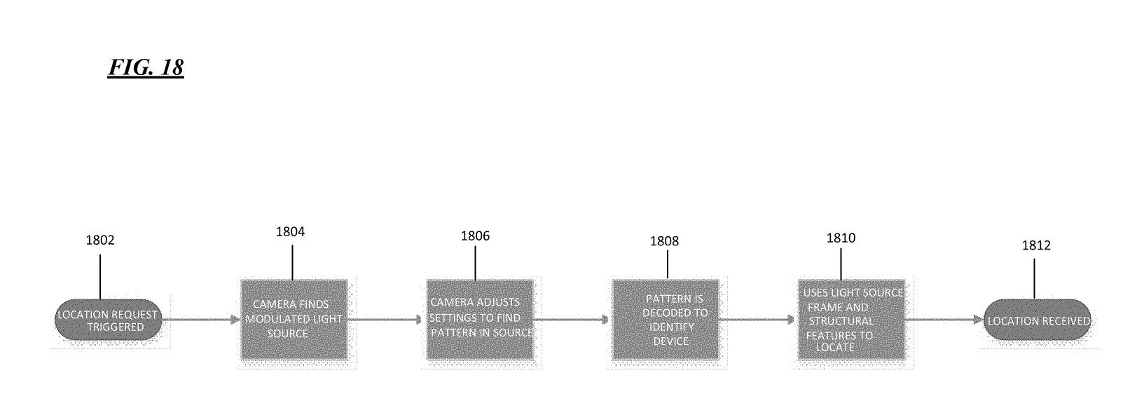

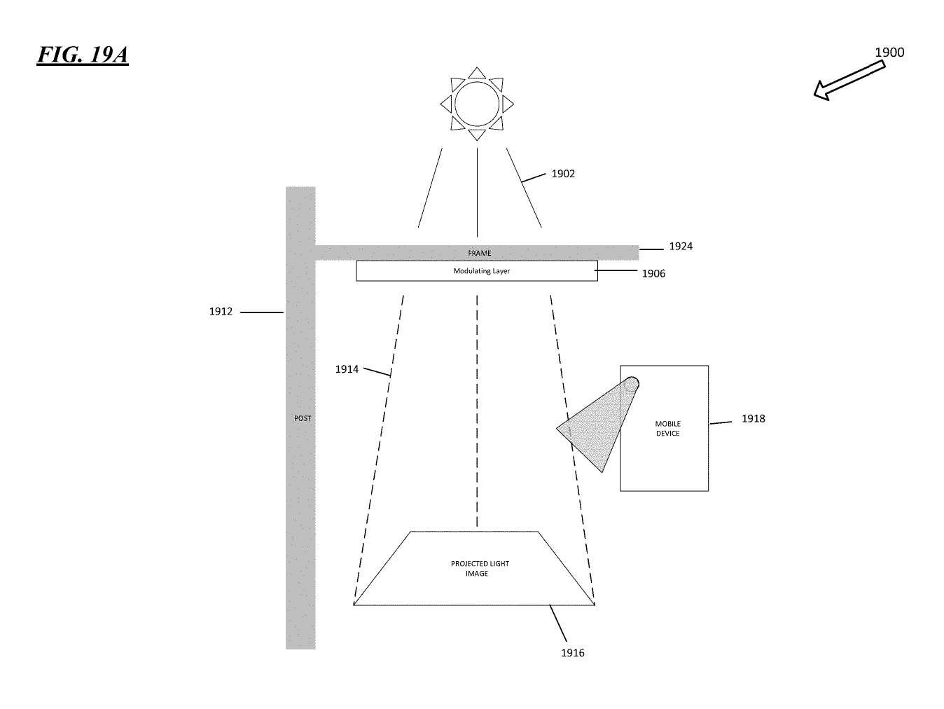

FIG. 18 is a flowchart of operation of a system with a mobile device in one of the systems 1700 and 1701 providing VLC using modulated lighting from a passive light source in an outdoor or partially enclosed space for a location estimation application.

The process begins at step 1802 in which, in the case of positioning or location, a location request is triggered using, for example, a mobile application that is activated by the user, automatically activated based upon, for example, a signal received from a wireless RF device that the mobile device is within a particular range of the system, or when a GPS service or signal is not precise enough. In step 1804, a sensor or mobile device directly observes or senses the modulated light output 1714 in FIGS. 17A, 17B, 17C and 17D. The sensor or mobile device may be, for example, a standalone camera, image sensor or other light sensors configured to detect visible light, e.g., in a user's mobile device or the like. Each modulated light output may include, for example, a device identification (ID) code for an outdoor mobile positioning and/or location based service. Network equipment may monitor and control aspects of the light communication operations, e.g. to identify devices using light communication services, determine amount of usage of the services, and/or control ID codes or other aspects of the light based communication transmissions.

In step 1806, the ISO or shutter settings of the sensor or mobile device can be adjusted to optimize for detection of the modulated light output 1714. The detected modulated light output pattern is decoded and a message is received in step 1808. In a case of data transmission, the process ends after the pattern is decoded and the message received at 1808. As described above with respect to the indoor position determination and/or related location based information, one or more light device ID codes obtained from processing of the captured image(s) may then be used in a table lookup in a databased (or in a portion of a database downloaded previously via the network to the mobile device 1710, for a related mobile device position estimation and/or for information retrieval functions.

In the location estimation example, the message may be a code to indicate (or be processed to determine) a location of the modulating layer. In such an application, after the pattern is decoded and the message is received, at step 1810, the frame of the modulating layer or other structure features may be used for fine positioning. The location is received and the process ends at 1812.

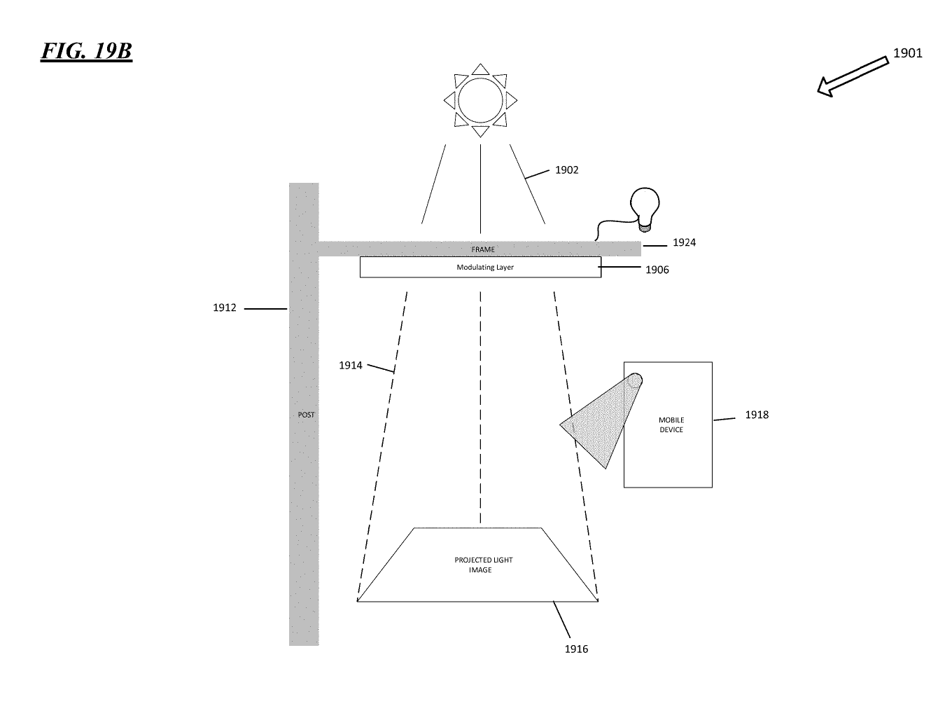

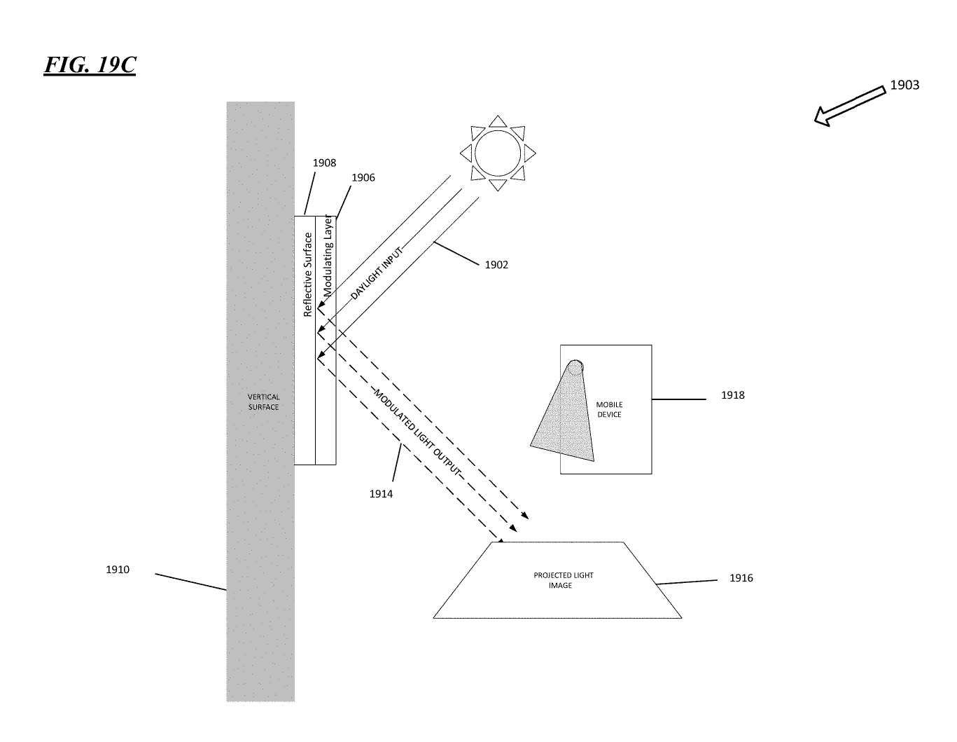

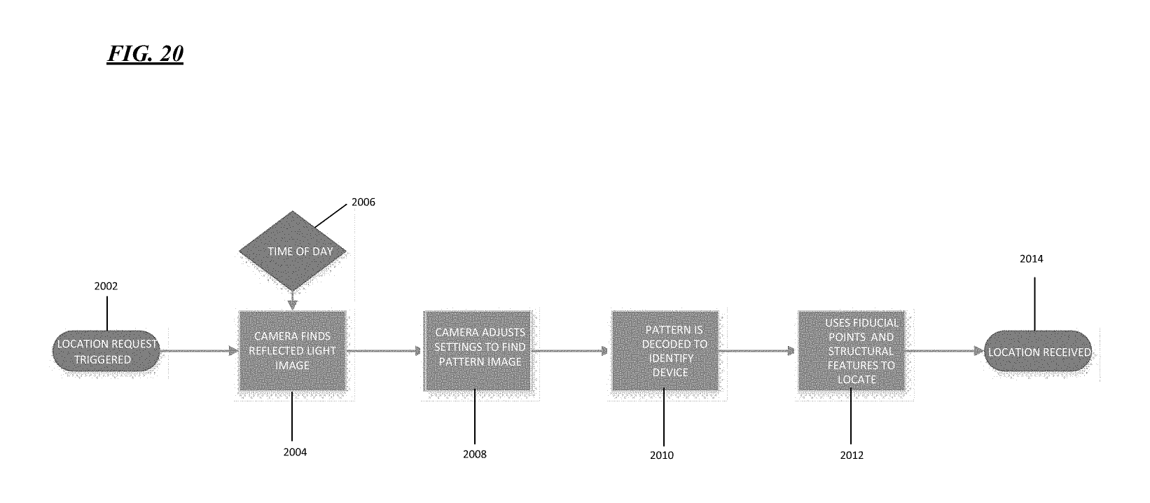

FIG. 19A illustrates a system 1900 for extending VLC to an outdoor area or partially enclosed area in which a modulating layer is positioned overhead, and a mobile device has an indirect view of a projected modulated signal or pattern.

In system 1900, a modulating layer 1906 is framed in an overhead position with respect to a mobile device 1918 configured to sense visible light. Specifically, a frame 1924 is fixedly supported by a post 1912 such that rays of light 1902 from a passive light source, for example, sunlight or other natural light, pass through the frame 1924 to the modulating layer 1906. In an alternate example illustrated in FIG. 19B, when there is insufficient natural light, the frame 1924 can be a luminaire or an artificial light source such as an overhead street light in which the modulating layer 1906 is thereby attached. Thus, light from the artificial light source would pass through to the modulating layer 1906. The light passing through to the modulating can be only light from the artificial source or a combination of the artificial light and the passive light source.

The frame 1924 with the modulating layer 1906 attached thereon can include any passive optical element structure such as transparent or translucent glass, an acrylic or plastic member in the form or part of a window, a skylight, partially enclosed pavilion, skywalk, seating area, or other device or structure that provides physical enclosure on at least one side of and structural support for the modulating layer 1906. When the natural light 1902 and/or artificial light from the artificial source passes through the modulating layer 1906, the passively supplied light is modulated to provide a modulated signal or pattern that is projected as a light image onto a surface positioned below the frame 1924 and modulating layer 1906. The surface may be, for example, a wall, screen or any object or material in which an image may be viewed such as a building or structure, a light pole or the ground surface. A mobile device 1918 observes the projected modulated light image 1916. The mobile device 1918 may be, for example, a standalone camera (e.g. a rolling shutter camera or a global shutter camera), image sensor, or light sensor, or a mobile handheld device that includes a camera such as a cell phone, tablet computer or gaming device configured to detect visible light.

The modulating layer 1906 modulates light wavelengths in a range encompassing at least a substantial portion of the visible light spectrum. The modulating layer 1906 is a material having a very high turn off/on speed faster than, for example, the materials of a liquid crystal display, for example, a holographic polymer dispersed liquid crystals (HPDLC), Pi-Cell, or Twisted Nematic.

The modulating layer 1906 may also be implemented to include a device such as a high speed piezo electric driver arranged to move multiple layers, for example, transparency layers each having a grating or pattern, to create a shuttering effect in which the light 1902 passes through to provide the modulated signal or pattern 1914. Examples of the high-speed piezo electric drive include ultrasonic resonant motors, piezo linear motors, and co-fired piezo electric stacks or similar devices known in the art to perform such functions.

FIG. 19C illustrates a system 1903 for extending VLC to an outdoor area or partially enclosed area in which a modulating layer 1906 is arranged on a reflective surface 1908 that reflects modulated data or natural light, and a mobile device has an indirect view of a projected modulated signal or pattern.

In system 1903, a modulating layer 1906 is mounted on a vertical surface 1910 having a reflective surface 1908 thereon, for example, aluminum, a highly reflective white paint or other colored paint within the visible spectrum having reflective properties, for example, colors such as red, green or blue. Passively supplied light 1902, for example, sunlight or other natural light, passes through the modulating layer 1906 and is reflected by the reflective surface 1908 to provide a modulated light output signal or pattern 1914. The modulated light output 1914 is projected onto a surface 1916, such as, for example, a ground surface, building or structure. The projected modulated light output signal is viewed from the surface 1916 by a mobile device 1918 which may include a standalone camera, image sensor or any light sensors, or a mobile handheld device having a camera, such as a cell phone, tablet computer, or gaming device configured to detect visible light. The vertical surface 1910 for the modulating layer 1906 and the reflective surface 1908 can be any passive optical element or structure including transparent or translucent glass, an acrylic or plastic member in the form or part of a window, a skylight, partially enclosed pavilion, or other device or structure that provides physical enclosure on at least one side of and structural support for the modulating layer 1906 and the reflecting surface 1908. Although shown and described as “vertical”, the surface 1916 may be somewhat angled, so long as the supported reflective surface 1908 can still adequately reflect/redirect the natural light to a desired space or area.

FIG. 20 is a flowchart of operations of a system with a mobile device in one of the systems 1900, 1901 and 1903 of FIGS. 19A, 19B and 19C providing VLC using modulated passive lighting in an outdoor or partially enclosed space.

The process begins at step 2002 in which, in the case of use of the system for positioning or location, a location request is triggered using, for example, a mobile application that is activated by the user, automatically activated based upon, for example, a signal received from a wireless RF device that the mobile device is within a particular range of the system, or when a GPS service or signal is not precise enough.

In step 2004, a sensor or mobile device observes or senses the modulated light output 1914 in FIGS. 19A, 19B and 19C. The sensor or mobile device may be, for example, a standalone camera, image sensor or light sensors configured to detect visible light, e.g. in a user's mobile device or the like. In systems 1900, 1901 and 1903, the mobile device or sensor 1916 does not observe the modulated light output 1914 directly from the source, rather the modulated light output 1914 is observed from the projected light image 1916. When there is an indirect observation of the modulated image data, in step 2006, it is necessary to also include consideration for time of day and season of the year because of the angular shifts and positions of the natural light source due to the time of day and season. In step 2008, the ISO or shutter settings of the sensor or mobile device can be adjusted to optimize for detection of the modulated light output 1914. The detected modulated light output signal or pattern is decoded and a message is received in step 2010.

At step 2012, fiducial points or known structural points in the surrounding area are taken into consideration to aid in the positional location determination. The fiducial points may include, for example, rocks, structures, objects in the pavement, etc. that a camera or image sensor can detect and use as an additional reference point for the location determination. One of ordinary skill in the art would recognize that global positioning satellite (GPS) can be used for outside general or gross positioning and location; however, the accuracy of GPS is only about 3 meters. Whereas, in the systems of FIGS. 19A, 19B, and 19C, a fine positioning accuracy of about 10 centimeters is achieved. As a result, the systems of FIGS. 19A and 19B are more accurate than GPS and can provide guidance to a more precise location position. After the location is received, the process ends at 2014

At least some functions using the modulated light transmissions from the modulating layer may be implemented on a portable handheld device, for example, the mobile device as illustrated and described with respect to FIGS. 17A, 17B, 17C, 17D, 19A, 19B and 19C. The portable handheld device 1000, as illustrated in FIG. 14, may also be used in the systems 1700, 1701, 1703 and 1705 of FIGS. 17A, 17B, 17C, and 17C, respectively, and systems 1900, 1901, and 1903 of FIGS. 19A, 19B and 19C, respectively. Specifically, the portable handheld device 100 includes at least one image sensor to capture an image of some portion or all of a modulating layer and/or a passive lighting element associated with the modulating layer. The signal generated by the light sensor comprises data representing the captured image and is responsive to received modulated light. It should be understood, however, that the portable handheld device 1000 may include other types of light sensors instead of or in addition to the image sensor(s). For purposes of discussion, we will consider a camera implementation of the light/image sensor.

In the example of FIG. 14, the mobile device 1000 further includes one or more cameras 1035 as well as camera subsystem 1037 coupled to the peripherals interface 1005. A smartphone or tablet type mobile station often includes a front facing camera and a rear or back facing camera. Some recent designs of mobile stations, however, have featured additional cameras. Although the camera 1035 may use other image sensing technologies, current examples often use a charged coupled device (CCD) or a complementary metal-oxide semiconductor (CMOS) optical sensor. At least some of such cameras implement a rolling shutter image capture technique, whereas other cameras implement a global shutter image capture technique. The camera subsystem 1037 controls the camera operations in response to instructions from the processor 1001; and the camera subsystem 1037 may provide digital signal formatting of images captured by the camera 1035 for communication data or other types of signal(s) representing each image via the peripherals interface 1005 to the processor or other elements of the device 1000.

The processor 1001 controls each camera 1035 via the peripherals interface 1005 and the camera subsystem 1037 to perform various image or video capture functions, for example, to take pictures or video clips in response to user inputs. The processor 1001 may also control a camera 1035 via the peripherals interface 1005 and the camera subsystem 1037 to obtain data detectable in a captured image, such as data represented by a code in an image or in visible light communication (VLC) detectable in an image. In the data capture case, the camera 1035 and the camera subsystem 1037 supply image data via the peripherals interface 1005 to the processor 1001, and the processor 1001 processes the image data to extract or demodulate data from the captured image(s). Alternatively, the camera subsystem 1037 may implement sufficient processing capability to, when instructed, perform some or all of VLC data demodulation function and simply provide demodulated data to the host processor 1001.

Voice and/or data communication functions are supported by one or more wireless communication transceivers 1039. In the example, the mobile device includes a cellular or other mobile transceiver 1041 for longer range communications via a public mobile wireless communication network. A typical modern device, for example, might include a 4G LTE (long term evolution) type transceiver. Although not shown for convenience, the mobile device 1001 may include additional digital or analog transceivers for alternative wireless communications via a wide area wireless mobile communication network.

Many modern mobile devices also support wireless local communications over one or more standardized wireless protocols. Hence, in the example, the wireless communication transceivers 1039 also include at least one shorter range wireless transceiver 1043. Typical examples of the wireless transceiver 1043 include various iterations of WiFi (IEEE 802.11) transceivers and Bluetooth (IEEE 802.15) transceivers, although other or additional types of shorter range transmitters and/or receivers may be included for local communication functions.

The data communication functions offered by transceiver 1039 or the transceiver 1043 may be used in conjunction with VLC data received from a modulating layer 1706 or 1906 to provide map or other location related information corresponding to a VLC identified modulating layer 1706 or 1906 or corresponding to a position estimated based on VLC data from a modulating layer 1706 or 1906.

As noted earlier, the memory 1007 stores programming 1009 for execution by the processor 1001 as well as data to be saved and/or data to be processed by the processor 1001 during execution of instructions included in the programming 1007. For example, the programming 1007 may include an operating system (OS) and programming for typical functions such as communications (COMM.), image processing (IMAGE PROC′G) and positioning (POSIT′G). Examples of typical operating systems include iOS, Android, BlackBerry OS and Windows for Mobile. The OS also allows the processor 1007 to execute various higher layer applications (APPs) that use the native operation functions such as communications, image processing and positioning. For example, receiving data from a modulating layer 1706 or 1906 may use the image processing function, and the positioning function may be configured to determine an estimated position of the device 1000 from either one or both of GPS or VLC (and/or other supported technologies such as Bluetooth). One or more of the higher layer applications will configure the device to utilize the data demodulated from received VLC, for example, to present a representation of the estimated device position, information obtain from communication with a server or the like that corresponds to the estimated position or to present content received via VLC from a modulating layer 1706 or 1906.

In another example, a personal computer is a user device that may receive VLC transmission, e.g. as a portable alternative to the mobile device 1710 and 1918. In any case, from the user's perspective, such mobile or portable user computer devices are often implemented to run “client” programming to obtain and/or ‘consume’ services from a general class of data processing device commonly used to run “server” programming. The server computer may be configured to implement the functions of computer 29 and/or store the database 31 that provide the VLC services discussed above. Those skilled in such hi-tech computer devices will likely be familiar with the overall structure, programming and operation of the various types of user/client devices and server computer devices. For completeness, however, it may be helpful to summarize relevant aspects of such computer devices by way of examples of devices 27, 29 previously discussed with respect to FIG. 2 and having similar application to the systems described in FIGS. 17A, 17B, 17C, 17D, 19A, 19B and 19C.

At a high level, a general-purpose computing device, computer or computer system typically comprises a central processor or other processing device, internal data connection(s), various types of memory or storage media (RAM, ROM, EEPROM, cache memory, disk drives etc.) for code and data storage, and one or more network interfaces for communication purposes. The software functionalities involve programming, including executable code as well as associated stored data, e.g. files used for the VLC service/function(s). The software code is executable by the central processing unit of the general-purpose computer that functions as the server 29 and/or that functions as a user terminal device 27. In operation, the code is stored within the general-purpose computer platform. At other times, however, the software may be stored at other locations and/or transported for loading into the appropriate general-purpose computer system. Execution of such code by a processor of the computer platform enables the platform to implement the respective functions relating to or utilizing VLC via a modulating layer 1706 and 1906, in essentially the manner performed in the implementations discussed and illustrated herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. For example, unless expressly state otherwise, a parameter value or the like may vary as much as ±10% from the stated amount.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A system for visible light communication, comprising:
an optical modulator including a modulating layer to modulate passively received light for modulated emission in at least one of an outdoor area or partially enclosed space;
a controller coupled to control the modulator to modulate data on the received light and include the data in the modulated emission in the at least one of an outdoor area or partially enclosed space; and
a mobile device configured to receive the modulated emission from the modulator.

2. The system of claim 1, further comprising a plurality of optical modulators each modulating the passively received light in the at least one of the outdoor area or partially enclosed space.

3. The system of claim 1, wherein the optical modulator comprises a framing structure having the modulating layer attached thereon.

4. The system of claim 3, wherein the framing structure comprises a passive optical element that is at least substantially transmissive with respect to visible light.

5. The system of claim 4, wherein the passive optical element includes transparent or translucent glass, a skylight, or a partially enclosed pavilion.

6. The system of claim 3, wherein the framing structure includes an artificial light source arranged to provide light to the modulating layer attached thereon.

7. The system of claim 1, wherein the controller is configured to control the modulator to modulate data on the received light for at least one of information about a location of the modulator and broadband user data.

8. The system of claim 1, wherein the optical modulator is configured to modulate light wavelengths in a range encompassing at least a substantial portion of the visible light spectrum.

9. The system of claim 1, wherein the controller comprises:
a processor coupled to the modulator; and
a network communication interface coupled to the processor,
wherein the processor is configured to cause the modulator to modulate data, received from a network via the interface, on the light emitted from the modulator to the non-enclosed space.

10. The system of claim 1, wherein the mobile device receives the modulated emission directly from the modulator.

11. The system of claim 1, wherein the mobile device receives the modulated emission from a surface having the modulated emission from the modulator projected thereon.

12. The system of claim 1, wherein the optical modulator further includes a reflective layer having the modulating layer directly attached thereon.

13. The system of claim 11, wherein the optical modulator is positioned at an angle 0°<x<180° from the mobile device.

14. The system of claim 1, wherein the optical modulator is positioned within a direct line of sight of the mobile device.

15. A portable device, comprising:
a light sensor;
a processor coupled to the light sensor;
a memory coupled to be accessible to the processor; and
programming in the memory for execution by the processor to configure the portable handheld device to perform functions, including functions to:
generate by the light sensor a signal responsive to modulated natural light received by the sensor from an optical modulator including a modulating layer; and
process by the processor the signal generated by the light sensor to obtain information transported by the modulated natural light from the modulator.

16. The portable device of claim 15, wherein the portable handheld device further performs functions to:
generate by the light sensor a signal responsive to modulated artificial light received by the sensor from the optical modulator including the modulating layer; and
process by the processor the signal generate by the light sensor to obtain information transported by the modulated artificial light from the modulator.

17. The portable device of claim 15, wherein:
the light sensor comprises a camera controlled by the processor to capture an image of some portion or all of modulated emission from the modulator,
the signal generated by the light sensor comprises data representing the image captured by the camera, and
the function to process the signal determines an identification (ID) code of the optical modulator from the modulated emission representing the image.

18. The portable device of claim 17, wherein execution of the programming further configures the portable handheld device to obtain an estimation of position of the portable handheld device using the ID code of the optical modulator.

19. The portable device of claim 15, wherein
the function to process the signal comprises demodulating data carried by a modulated emission from the optical modulator, and
execution of the programming further configures the portable handheld device to process the demodulated data as user data intended for the portable handheld device.

20. The portable device of claim 15, wherein the portable handheld device further performs functions to:
generate by the light sensors a signal responsive to modulated light received by the sensor from a plurality of optical modulators each including a modulating layer; and
process by the processor the signal generated by the light sensor to obtain information transported by the modulated natural light from the plurality of modulators and modulating layers.
